(19) United States
(12) Patent Application Publication
(10) Pub. No.: US 2001/0038742 A1
(43) Pub. Date: Nov. 8, 2001

(54) VIDEO MANAGING SYSTEM AND VIDEO MANAGING METHOD

(76) Inventor: AKIRA TAKANO, KANAGAWA (JP)

Correspondence Address: FROMMER LAWRENCE & HAUG, 745 FIFTH AVENUE- 10TH FL., NEW YORK, NY, 10151, US

(21) Appl. No.: 09/125,050

(22) PCT Filed: Dec. 9, 1997
(86) PCT No.: PCT/JP97/04524

§ 371 Date: None

(30) Foreign Application Priority Data
Dec. 9, 1996 (JP) 8-346631

(51) Int. Cl. H04N 5/93; G11B 27/02; G11B 27/00

(52) U.S. Cl. 386/52; 386/81; 360/13; 386/83

(57) ABSTRACT

A picture management system, which can carry out an editing work easily and can manage a picture material edited or in the course of editing smoothly, is proposed.

A digital video cassette recorder (13) compresses an index picture used as an editing point on the basis of an index information such as a mark-in point or the like recorded on a video tape or a contained memory attached to a cassette of a digital video cassette (12) and produces a simple index picture. Since the editing is performed by linking this simple index picture with the picture materials, the editing work becomes extremely easy. The simple index picture is also added to a picture material on a video tape edited or in the course of editing by the instruction of an editing device (14). By utilizing this simple index picture, the confirming work of the contents of the video tape becomes easy, and further, the unitary management of the video tape becomes possible.

### TECHNICAL FIELD

The present invention relates to a picture management system and a picture management method for performing the editing and the management of picture information recorded on a recording medium such as a video tape or the like.

### BACKGROUND ART

Previously, there has been proposed an off line editing as one method for editing picture information recorded on a recording medium such as a video tape. The off line editing is such a method that a picture information recorded on an original tape at the site of the picture taking is once copied on another recording tape, that is, an editing tape, and on this editing tape, editing data such as an editing point and so on are produced, and on the basis of the editing data, a master tape is produced. In this off line editing, a desired master tape can be produced without accidentally eliminating or rewriting the important recording information on the original tape.

However, in the off line editing, since the editing work is performed by using the editing tape copied from the original tape, there is such a problem that when copying the information on an original tape to an editing tape, time and labor are taken Furthermore, when producing the editing data by using the editing tape, for ensuring an approach running period of the tape in advance, a pre-roll is inevitable, and further, since an access to a target editing point takes time, there is such a problem that production of editing data inevitably extremely takes time.

Therefore, as one method to solve the above-mentioned problems, there is such a method that the information on an original tape is once copied on a disk-like recording medium such as a hard disk or the like in which recording is possible and random access is possible, and by using the copied information on the disk-like recording medium, the editing data are produced. By this method, since the access to the editing point can be performed in a short period of time, it is possible to decrease the time required for the editing work.

However, this method has such a problem that for recording all information on the original tape in a disk-like recording medium, a lot of recording capacity is necessary for a disk-like medium, and it is actually difficult to realize a disk-like recording medium fulfilling such a recording capacity. Furthermore, in a case of using a disk-like recording medium, there is also such a problem that the copy from the original tape to a disk-like recording medium inevitably takes a lot of time similarly to the case of using an editing tape.

Therefore, the present applicant proposes, as a method to largely increase the efficiency of editing work, such a method that when taking a picture, a small screen is produced by compressing and reducing the head picture (static picture) of each scene, and an index picture information made by arranging a plurality of these small screens in 1 piece of frame is recorded on a video tape. By this method, at the time of editing, it is possible that the index picture information is reproduced and displayed, and a necessary scene is selected, and only the information of the necessary scene is transferred from the video tape to the disk-like recording medium, and consequently, the time required for the editing work can largely be decreased.

The above mentioned editing work is performed by an editing device generally called a non linear editing machine. The non linear editing machine is such a device that picture voice information is recorded on a recording medium in which random access is possible, and the editing can be performed in an arbitrary order. However, in the prior art, the information which is selectively transferred from a video tape to a disk-like recording medium of the non linear editing device and is subjected to the editing work, has been only the picture information of the scene (material) and the information showing the editing point thereof. Therefore, in the editing work, the editing should be performed by retrieving the picture information of the material, only on the basis of such information showing the editing point, and the editing work has not always been easy.

Furthermore, in order to concretely confirm the contents of a tape in which editing is finished or a tape in the course of editing, the work to reproduce the tape and to actually confirm the edited picture or the picture in the course of editing recorded therein, is necessary, and the work takes time and is not easy.

Furthermore, usually, a case where an emergency editing of another editing tape becomes necessary while editing picture materials recorded on some editing tape by using a non linear editing machine, occurs frequently. In that case, since the memory capacity of a disk-like recording medium in the non linear editing device has a limit, it is necessary that the contents of the editing tape in the course of editing is once retreated into another backup tape and a space is ensured on the disk-like recording medium. It is not inevitably necessary that such a backup is performed for all materials on the disk-like recording medium, and it is suitable that only the minimum necessary materials sufficient for ensuring the space necessary for the emergency editing of another editing tape, are backed up. Furthermore, among the picture materials transmitted from a video tape to a disk-like recording medium of a non linear editing device for performing the editing work, there are some materials judged to be unnecessary according to the progress of the editing. Accordingly, in that case, it is also desirable to back up such unnecessary materials into another tape, considering the limited memory capacity of a disk-like recording medium. However, in the prior art, there has been such a problem that in that case, the work to specify the materials to be backed up is troublesome, and is not speedy.

Furthermore, in a conventional editing device, as for such a backup tape in which backup data are recorded, or a tape in which editing is finished or is being performed, the addition of each inherent management information has not been performed. Therefore, it has been difficult to perform the unitary management of these various types of tapes.

### DISCLOSURE OF THE INVENTION

The present invention is made in view of such problems, and an object thereof is to provide a picture management system by which the treatment of a picture material such as editing work or the like can be easily performed, and a picture material which is finished in edition or whose edition is being performed can be smoothly managed.

The picture management system according to the present invention comprises: a simple index picture producing means which selects an index picture from among the picture informations recorded on a recording medium on the basis of an index information to specify an editing point or an editing range on the recording medium and produces a simple index picture capable of being simply displayed based on the selected index picture; a simple index picture adding means which adds the simple index picture produced by the simple index picture producing means to each picture information recorded on the recording medium; and a picture treating means which treats the picture information recorded on the recording medium in a link with the simple index picture added by the simple index picture adding means. Here, the picture treating means is a means to perform, for example, an editing work, a backup of the recording medium, management of the number of a recording medium, and the like.

Here, for example, it is also possible that the simple index picture adding means is arranged to have a function to add a simple index picture to each picture information on a recording medium in which editing is finished or is being performed, or to have a function to add a simple index picture to each picture information on a backup recording medium in which picture information is backed up and recorded. Furthermore, it may also be arranged to display the simple index picture as a guidance for the editing result. Moreover, it may also be arranged to add management information for managing that recording medium, to the recording medium in which editing is finished or is being performed, or the backup recording medium in which picture information is backed up and recorded. This management information may be arranged to include, for example, an inherent identification information (such as a number of a recording medium or the like) of each recording medium.

In the picture management system of the present invention, an index picture is selected from among the picture information on the recording medium on the basis of the index information, and on the basis of this index picture, a simple index picture is produced, and also the produced simple index picture is added to each picture information on the recording medium. Then, the treatment to the picture information on the recording medium is performed at least by using such a simple index picture. That is, in the picture management system of the present invention, since each picture information as a material is organically connected to each of the simple index pictures, the editing work, the management of the picture materials, and the like can be performed on the basis of these simple index pictures.

### BRIEF DESCRIPTION OF THE DRAWINGS

FIG. 1 is an explanatory diagram showing the arrangement of a whole picture processing system including a picture management system according to one embodiment of the present invention;

FIG. 2 is a block diagram showing the arrangement of a digital VTR section in a camera.recorder shown in FIG. 1;

FIG. 3 is a block diagram showing the arrangement of a digital video cassette recorder shown in FIG. 1;

FIG. 4 is an explanatory diagram showing a communication means with a memory attached to a cassette in a digital video cassette shown in FIG. 1;

FIG. 5 is an explanatory diagram for describing the protocol at the time of write in of data to the memory attached to a cassette;

FIG. 6 is an explanatory diagram showing the relation between a serial data and a serial clock in FIG. 5;

FIG. 7 is an explanatory diagram for describing the protocol at the time of read out of data from the memory attached to a cassette;

FIG. 8 is an explanatory diagram showing the arrangement of a pack as a unit of data recorded in a memory attached to a cassette;

FIG. 9 is an explanatory diagram showing a data format of the memory attached to a cassette;

FIG. 10 is an explanatory diagram showing the outline of the contents of a pack related to an index picture used in a picture management system according to one embodiment of the present invention;

FIG. 11, FIG. 12, FIG. 13, and FIG. 14 are each an explanatory diagram showing the outline of the contents of a pack related to an index picture used in a picture management system according to one embodiment of the present invention;

FIG. 15 is an explanatory diagram showing the detailed contents of a pack shown in FIG. 10;

FIG. 16 is an explanatory diagram showing the detailed description of a pack shown in FIG. 11;

FIG. 17 is an explanatory diagram showing the detailed contents of a pack shown in FIG. 12;

FIG. 18 is an explanatory diagram showing the detailed contents of a pack shown in FIG. 13;

FIG. 19 is an explanatory diagram showing the detailed description of a pack shown in FIG. 14;

FIG. 20 is an explanatory diagram showing the detailed contents of a management pack in FIG. 9;

FIG. 21 and FIG. 22 are each an explanatory diagram showing the detailed contents of a reel number pack in FIG. 9;

FIG. 23 is an explanatory diagram showing a recording pattern on a video tape in a digital video cassette shown in FIG. 1;

FIG. 24 is an explanatory diagram showing the arrangement of data recorded in the audio data section in FIG. 23;

FIG. 25 is an explanatory diagram showing the arrangement of data recorded in the video data section in FIG. 23;

FIG. 26 is an explanatory diagram showing the arrangement of data recorded in a sub code section in FIG. 23;

FIG. 27 is an explanatory diagram showing the layouts of an audio data section, a video data section, and a sub code section on a video tape;

FIG. 28 is an explanatory diagram showing the physical layout of the sub code data on a video tape;

FIG. 29 and FIG. 30 are each an explanatory diagram showing the format of the sub code section on a video tape;

FIG. 31 is an explanatory diagram showing the state of a video tape when a mark-in point and a mark-out point are specified at the time of recording of the picture information in one embodiment of the present invention;

FIG. 32 is an explanatory diagram showing one example of the state of a video tape at the time of producing an index picture information in one embodiment of the present invention;

FIG. 33 is an explanatory diagram showing another example of the state of a video tape at the time of producing the index picture information in one embodiment of the present invention;

FIG. 34 is an explanatory diagram for describing one example of the picture displayed by the index picture information in one embodiment of the present invention;

FIG. 35 is a flow chart showing one example of the index picture selecting action in one embodiment of the present invention;

FIG. 36 is a block diagram showing the rough arrangement of the picture management system in one embodiment of the present invention;

FIG. 37 is a block diagram showing the arrangement of the system overall control section in FIG. 36;

FIG. 38 is a block diagram showing the arrangement of an VTR/DISK control section in FIG. 36;

FIG. 39 is a block diagram showing the arrangement of an SDDI section in FIG. 36;

FIG. 40 is a block diagram showing the arrangement of a disk control section in FIG. 36;

FIG. 41 is a flow chart for describing the principal part of the contents of the action of the system overall control section shown in FIG. 37;

FIG. 42 is a flow chart following FIG. 41;

FIG. 43 is a flow chart for describing the principal part of the contents of the action of the VTR/DISK control section shown in FIG. 38;

FIG. 44 is a diagram showing one example of a picture displayed in the display section in FIG. 36;

FIG. 45, FIG. 46, and FIG. 47 are each a diagram showing another example of a picture displayed in the display section in FIG. 36;

FIG. 48 is a diagram showing an example of unedited pack data stored in the memory of the system overall control section;

FIG. 49 is a diagram showing an example of edited pack data stored in a memory of the system overall control section;

FIG. 50 is a diagram showing an example of an unedited index picture set screen presented by the index picture information stored in the memory of the system overall control section;

FIG. 51 is a diagram showing an example of an edited index picture set screen presented by the index picture information stored in the memory of the system overall control section;

FIG. 52 is a diagram showing another example of a picture screen displayed in the display section in FIG. 36;

FIG. 53 is a diagram showing an example of pack data at the time of backup stored in the memory of the system overall control section; and

FIG. 54 is a diagram showing an example of an index picture set screen at the diagram of backup presented by the index picture information stored in the memory of the system overall control section.

### BEST MODE FOR CARRYING OUT THE INVENTION

One embodiment of the present invention will be described below in detail by referring to the drawings.

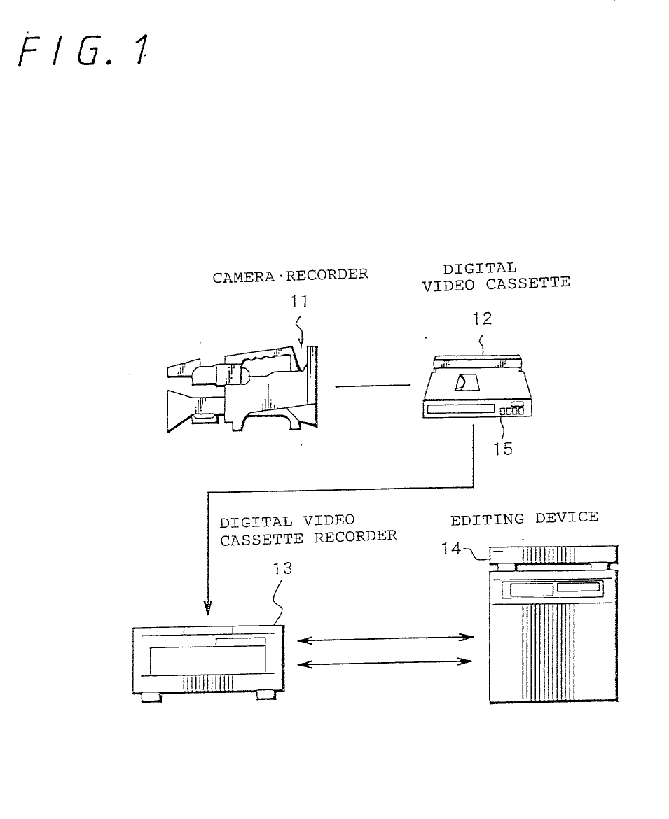

First, by referring to FIG. 1, the arrangement of a whole picture processing system to which a picture management system according to the present embodiment is applied, will be described. This system comprises: a camera.recorder 11 having a digital video camera section and a digital VTR section which records a video signal obtained upon taking a picture by this digital video camera section, into a digital video cassette 12 as a digital signal; a digital video cassette recorder 13 which performs reproduction and the like of a video signal recorded in the digital video cassette 12; and an editing device 14 which performs a non linear editing by using the information from the digital video cassette recorder 13. The digital video camera section and the digital VTR section in the camera.recorder 11 may be integrated, or may be separable. The digital video cassette 12 uses a video tape of, for example, 6.3 mm (¼ inch), and includes a memory attached to a cassette (not shown in the present figure) using a semiconductor memory in the cassette, and has a terminal 15 for connecting the memory attached to a cassette and an outside circuit, for example, at the back portion of the cassette. Furthermore, in the present embodiment, the digital video cassette recorder 13 shown in FIG. 1 corresponds to a simple index picture producing means in the present invention, and the editing device 14 and the digital video cassette recorder 13 correspond to the simple index picture adding means in the present invention, and the editing device 14 corresponds to a picture treating means.

Here, first, the camera.recorder 11, the structure of various types of data recorded in the digital video cassette 12, and the digital video cassette recorder 13 will be described.

[Arrangement of the Camera.Recorder 11]

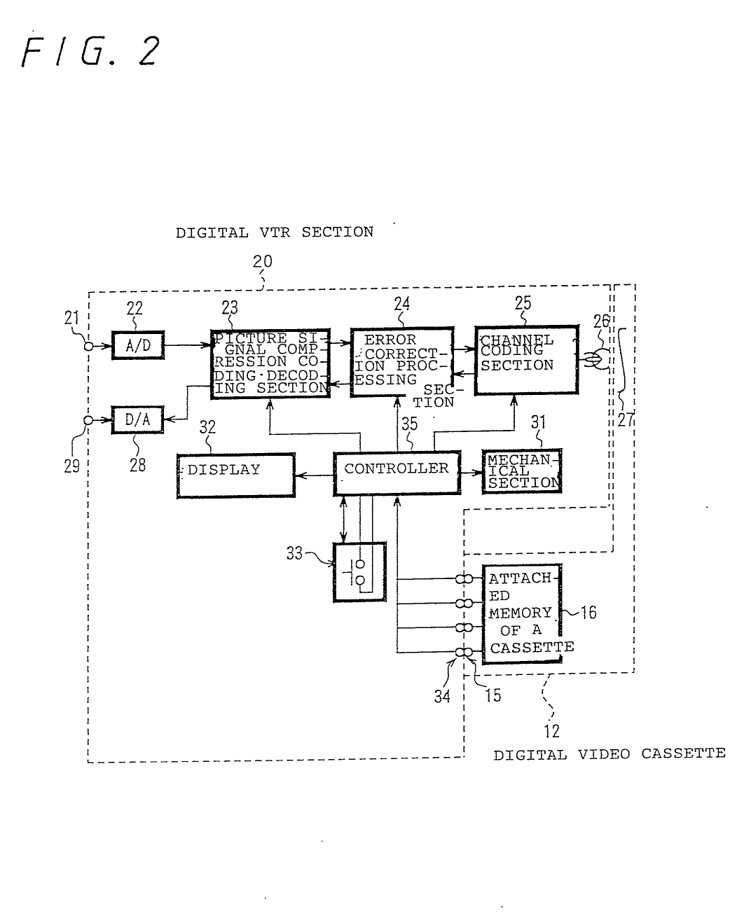

FIG. 2 is a block diagram showing the arrangement of the digital VTR section in the camera.recorder 11 shown in FIG. 1. This digital VTR section 20 comprises: an input terminal 21 to which a video signal from the digital video camera section is inputted; an output terminal 29 which outputs a video signal; an A/D converter 22 which converts a video signal inputted from the input terminal 21, in an analog-digital (hereafter, referred to simply as A/D) conversion; a video signal compression coding•decoding section 23 which performs the processing of compression coding of a video signal outputted from the A/D converter 22 and the processing of decoding (extension) of a signal reproduced from a video tape; and a D/A converter 28 which converts the signal decoded by the video signal compression coding.decoding section 23, in a digital-analog (hereafter, referred to simply as D/A) conversion, and outputs that to the output terminal 29. Furthermore, the video signal compression coding.decoding section 23 is arranged to perform the processing of compression coding by using the discrete cosine transformation (hereafter, referred to simply as DCT).

The digital VTR section 20 further comprises: an error correction processing section 24 which performs addition of an error correction code to the signal subjected to compression coding by the video signal compression coding.decoding section 23, and performs error correction processing to the signal reproduced from a video tape and outputs the signal to the video signal compression coding.decoding section 23; a channel coding section 25 which performs coding processing suitable for being recorded on a video tape, to the signal having an error correction code added by the error correction processing section 24, and performs decoding processing corresponding to this coding processing, to the signal reproduced from the video tape and outputs the signal to the error correction processing section 24; and a video head 26 which records the signal coded by the channel coding section 25 on a video tape 27 in the digital video cassette 12, and reproduces the signal recorded on the video tape 27 and outputs that to the channel coding section 25. Furthermore, it is arranged that the video head 26 includes a recording head and a reproducing head, and can perform recording and reproducing at the same time.

The digital VTR section 20 further comprises: a mechanical section 31 which performs loading of the digital video cassette 12, driving of a rotational drum having the video head 26 attached, and the like; a display 32 which performs various types of displays; an operational section 33 by which a user performs various types of operations; a terminal 34 for the connection with the terminal 15 connected to the attached memory 16 to the cassette in the digital video cassette 12; and a controller 35 connected to the video signal compression coding•decoding section 23, the error correction processing section 24, the channel coding section 25, the mechanical section 31, the display 32, the operational section 33, and the terminal 34.

The operational section 33 has a plurality of switches to perform predetermined instructions. In the present embodiment, as the switches, a mark-in switch for indicating a start point of the effective area in each scene or take, that is, a mark-in point; a mark-out switch for indicating a end point of the effective area in each scene or take, that is, a mark-out point; an OK/NG switch for indicating OK or NG (no good) to each scene or take; a take switch for indicating a take number; a cue switch for indicating a cue point to be an index arbitrarily specified by the user; and a mode change-over switch for changing over between a mark mode and a cue mode to be described later, are included. The OK/NG switch is arranged to be switched between the OK indication state and the NG indication state for each pressing. The take number is arranged to be increased each time the take switch is pressed. By the way, a switch for indicating the scene number is not provided, the reason of which is that the scene number is arranged to be automatically increased for each scene. The mark mode is a mode to make it possible that the user arbitrarily indicates the mark-in point and the mark-out point by using the mark-in switch and the mark-out switch, and the cue mode is a mode to make it possible that the user arbitrarily indicates a cue point by using the cue switch. In the cue mode, the start time of picture taking and the end time of picture taking of each scene are arranged to automatically become the mark-in point and the mark-out point. The operational section 33 may be provided integrally to the camera.recorder 11, or may be a remote control device. Furthermore, the mark-in point is arranged to be used as the in-point of the material used in editing.

The controller 35 is composed of a CPU (central processing unit), a ROM (read.only.memory), a RAM (random.access.memory), an input and output section, and the like, and is arranged to control the total of the digital VTR section 20 by performing the program stored in the ROM, by using the RAM as a working area.

[Arrangement of the Digital Video Cassette Recorder 13]

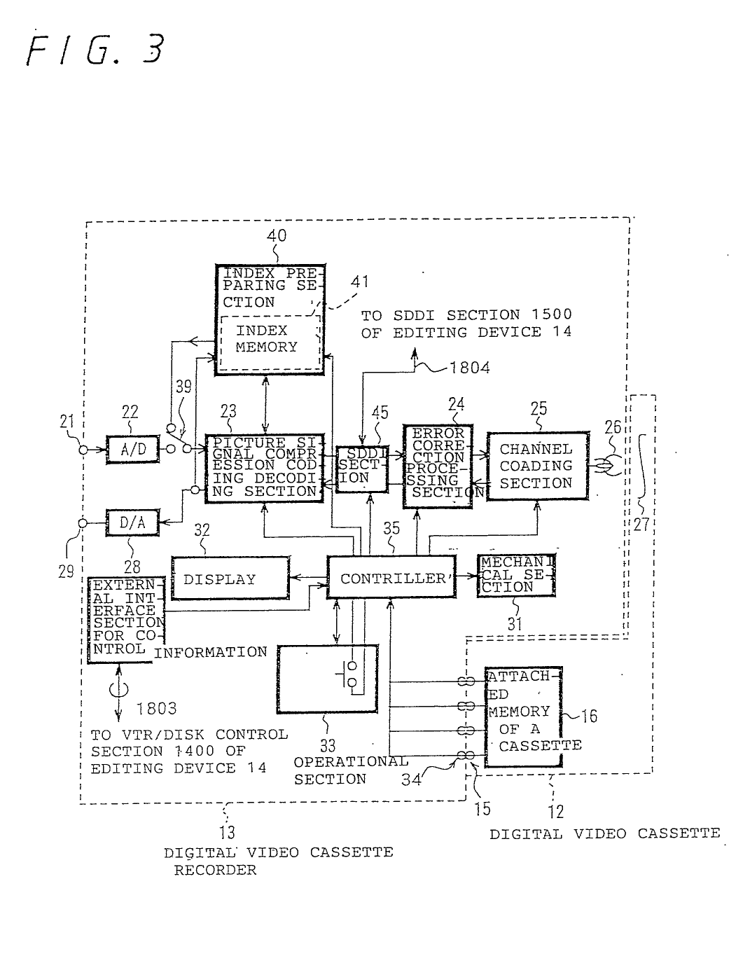

FIG. 3 is a block diagram showing the arrangement of the digital video cassette recorder 13 shown in FIG. 1. Since the almost all part of the arrangement of this digital video cassette recorder 13 is similar to the arrangement of the digital VTR section 20 shown in FIG. 2, the same marks are given to the components similar to those of the digital VTR section 20, and the description thereof will be omitted. The arrangement of the digital video cassette recorder 13 is different from that of the digital VTR section 20, in that an index producing section 40; a switch 39 which selects one of the output signal of this index producing section 40 and the output signal of the A/D converter 22 and outputs the same to the video signal compression coding.decoding section 23; an external interface section 45 for picture, voice, and sub code information (hereafter, referred to simply as an SDDI (serial digital data interface) section) which is provided between the video signal compression coding.decoding section 23 and the error correction processing section 24; and an external interface section 46 for control information which is connected to the controller 35, are newly provided, and that to the operational section 33, the function to indicate the production of index information is newly added.

Here, the index producing section 40 has a memory controller (not shown in the figure) and an index memory 41, and to which, the signal outputted from the video signal compression coding.decoding section 23 to the D/A converter 28 is arranged to be inputted. It is arranged that the index producing section 40 is controlled by the controller 35, and performs sending and receiving of a predetermined data to be described later, to and from the video signal compression coding.decoding section 23.

As described later, the SDDI section 45 is connected to an SDDI section 1500 of the editing device 14 by an SDDI cable 1804, and is arranged to be able to perform sending and receiving of video data.audio data, and sub code data. The SDDI section 45 further includes therein an internal switch (not shown in the figure) which changes over the inputting of the output from the video signal compression coding.decoding section 23 to the error correction processing section 24, in a through fashion or the inputting of video data and the like received from the editing device 14 to the error correction processing section 24, according to the instruction of the controller 35. On the other hand, the output from the error correction processing section 24 is arranged to be supplied to both the video signal compression coding.decoding section 23 and the SDDI section 45.

It is arranged that the external interface section 46 for control information is connected to a VTR/DISK control section 1400 of the editing device 14, and performs sending and receiving of various types of control information through that, and can perform sending and receiving of subordinate information such as a mark-in point, a mark-out point, or OK/NG.

As described later in detail, it is arranged that the controller 35 and the index producing section 40 select an index picture as an index image to be an aid at the time of performing editing, from the picture information recorded on the video tape 27, on the basis of the additional information of a mark-in point, a mark-out point, OK/NG, a take number, a cue point, and a scene number, and produce index picture information to simply display this index picture, and perform the action to record this index picture information on the video tape 27. In the present embodiment, the index picture information means the information to indicate a picture made by further arranging, in a sheet of frame, a plurality of index pictures each made by compressing and reducing each index picture (hereafter, referred to simply as a simple index picture), in other words, the picture information indicating a set screen of simple index pictures. Here, the information indicating the mark-in point, the mark-out point, and the cue point corresponds to the index information in the present invention, and the index picture corresponds to the index picture in the present invention, and the simple index picture corresponds to the simple index picture in the present invention. Furthermore, in the description below, the index picture is referred to as IP suitably.

In the present embodiment, when recording the picture information on the video tape 27 by the digital VTR section 20 shown in FIG. 2, or when reproducing the picture information recorded on the video tape 27, by the digital VTR section 20 or the digital video cassette recorder 13 shown in FIG. 3, it is possible to indicate the mark-in point, the mark-out point, OK/NG, the take number, and the cue point by using the operational section 33, and these indicated informations and the information of the scene number are arranged to be recorded in the attached memory 16 to the cassette in the digital video cassette 12 and on the video tape 27.

[Structure of the Digital Video Cassette 12 and the Digital Mechanism]

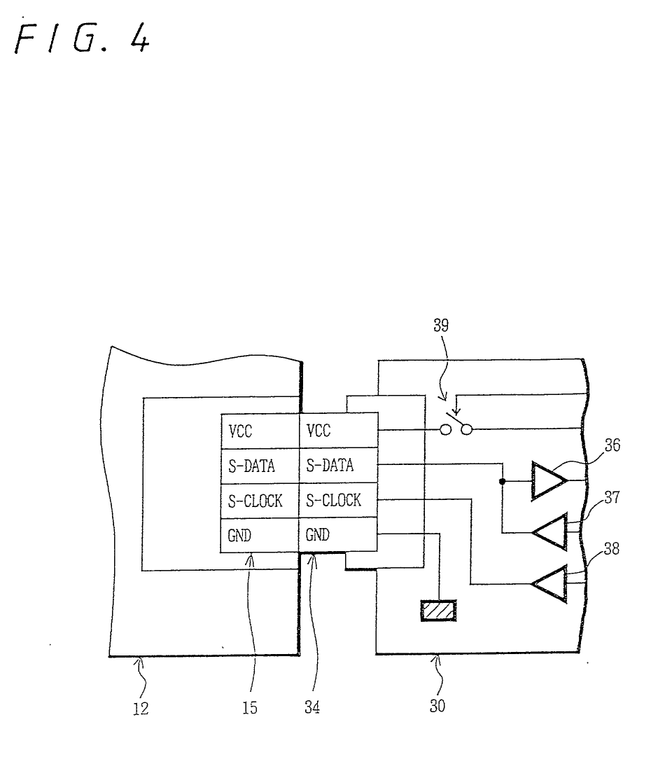

By referring to FIG. 4 to FIG. 7, one example of the communication means between the attached memory 16 to the cassette in the digital video cassette 12 and the digital VTR section 20 or the digital video cassette recorder 13 (hereafter, the digital VTR section 20 or the digital video cassette recorder 13 is referred to simply as a main body 30), will be described.

FIG. 4 shows one example of the arrangement of the terminal 15 on the digital video cassette 12 side and the terminal 34 on the main body 30 side, and the arrangement of the interface on the main body 30 side. Here, the main body 30 means the digital VTR 20 of the camera.recorder 11 shown in FIG. 2, and further, it means the digital video cassette recorder 13 shown in FIG. 3. In this example, the terminals 15, 34 are each composed of 4 pins, and the detail thereof is as follows: a power supply (VCC) pin, a serial data (S-DATA) pin, a serial clock (S-CLOCK) pin, and a ground (GND) pin, and the corresponding pins are arranged to be mutually connected. The power supply and the serial clock are arranged to be supplied from the main body 30. The ground pin is arranged to be grounded on the main body 30 side. The serial data pin is arranged to serve for common use to input and output. The interface on the main body 30 side has an input buffer 36 for wave form shaping whose input end is connected to the serial data pin, an output buffer 37 for wave form shaping whose output end is connected to the serial data pin, a serial clock buffer 38 whose output end is connected to the serial clock pin, and a switch 39 one end of which is connected to a power supply pin and the other end of which is connected to the power supply circuit in the main body 30. The main body 30 has a function to control ON/OFF of the power supply supplied to the digital video cassette 12, by using the switch 39, and this function functions as the reset of the attached memory 16 to the cassette.

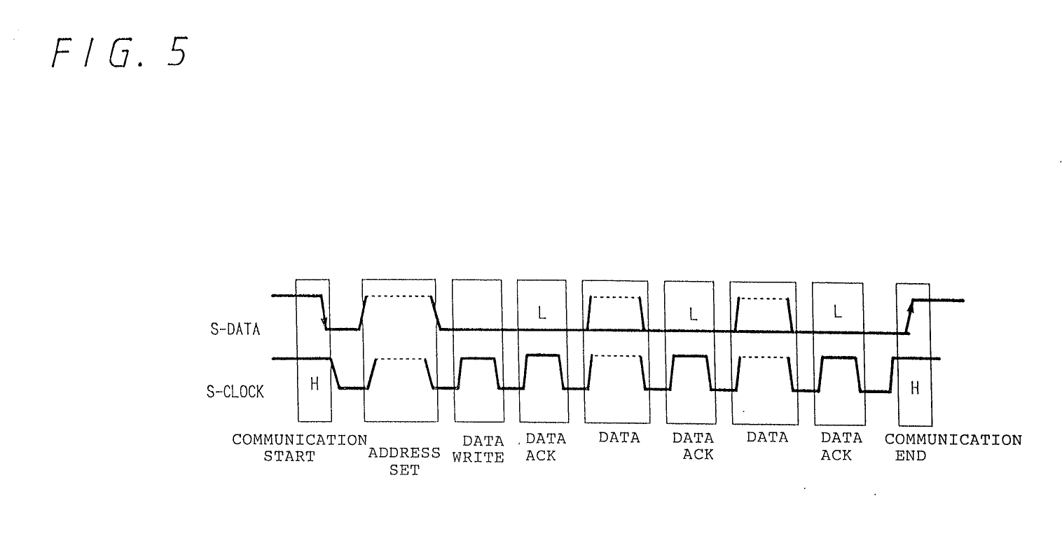

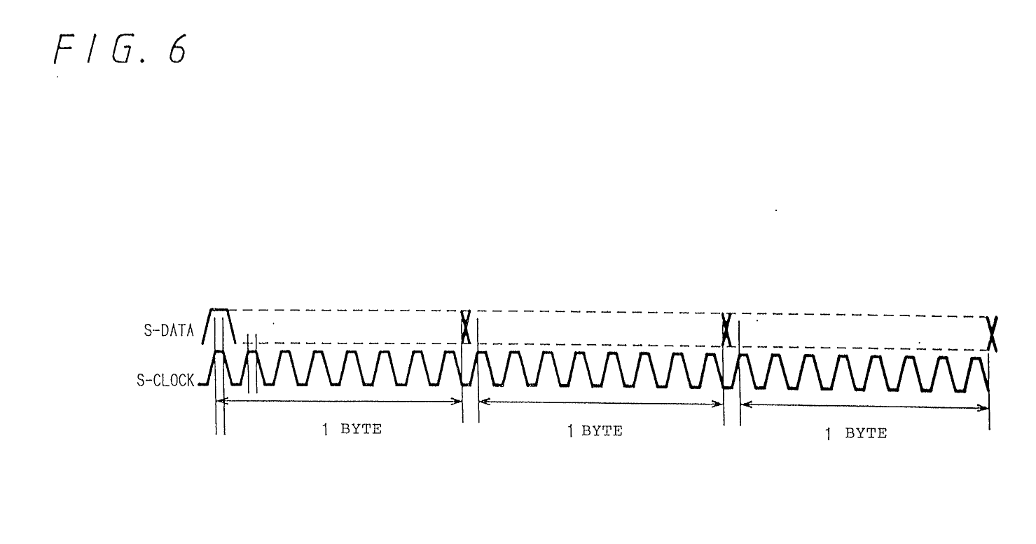

Next, by referring to FIG. 5 and FIG. 6, a protocol of communication at the time of write-in of the data from the main body 30 into the attached memory 16 to the cassette will be described. In the protocol at the time of write-in, as shown in FIG. 5, the communication starts at the trailing edge of the serial data S-DATA when the serial clock S-CLOCK is “H”. After that, an address of 3 bytes is set, and further, the period to indicate the write-in of the data (data write) from the main body 30 to the attached memory 16 to the cassette (the serial data S-DATA is “L” when the serial clock S-CLOCK is “H”), continues. At the time of receiving the data up to this, the attached memory 16 to the cassette outputs “L” to the serial data S-DATA in the next period of the data ACK. After that, the data are written in the attached memory 16 to the cassette while handshake is performed by the data ACK and the data, at every 1 byte. The number of data after address set has a variable-length. In FIG. 5, such an example that the data for 2 bytes are written at after the address of 3 bytes has been set, is shown. For example, if the set address is 0100 h (h shows a hexadecimal number), and the data are 0AA h and 055 h, the data 0AA h are written in the address 0100 h, and the data 055 h are written at the address 0100 h. The communication finishes at the leading edge of the serial data S-DATA when the serial clock S-CLOCK is “H”. The effective term of the data is the interval of “H” of the serial clock S-CLOCK. The relation between the serial data S-DATA and the serial clock S-CLOCK, as for the address set and the data, is shown in FIG. 6. As shown in this figure, 8 clocks are necessary for the transmission of 1 byte of address or data.

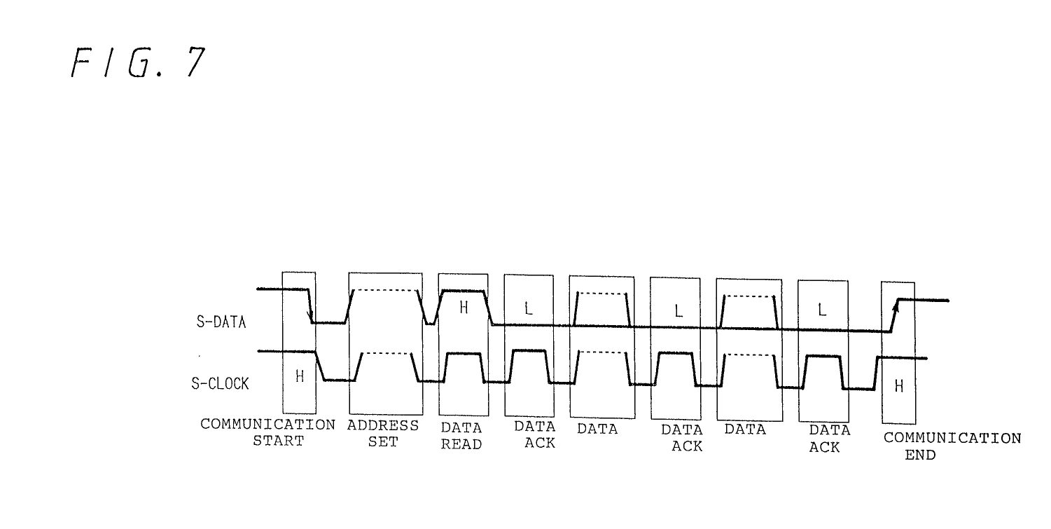

Next, by referring to FIG. 7, a protocol of communication at the time of read-out of data from the attached memory 16 to the cassette to the main body 30, will be described. When compared with the protocol at the time of write-in shown in FIG. 5, the protocol at the time of read-out is basically similar to the protocol at the time of read-out, except that after the address set, the period to indicate the read-out of the data (data read) from the attached memory 16 to the cassette to the main body 30 (the serial data S-DATA is “H” when the serial clock S-CLOCK is “H”), continues instead of the period to indicate the data write.

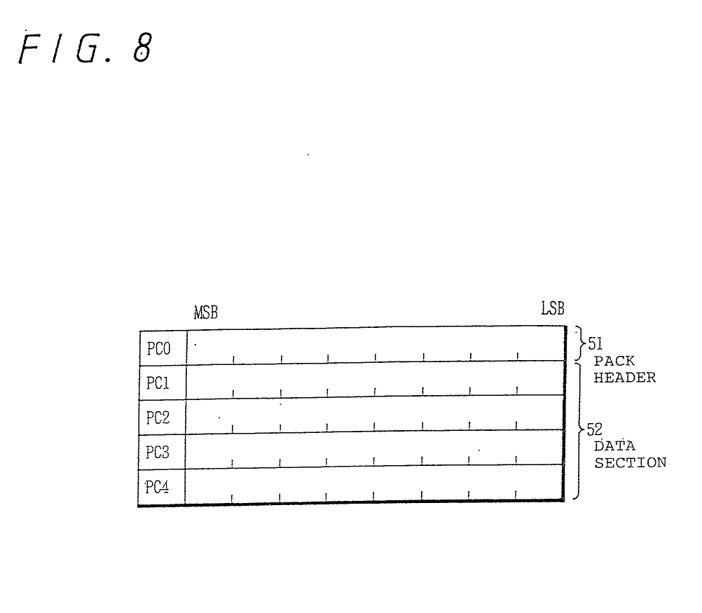

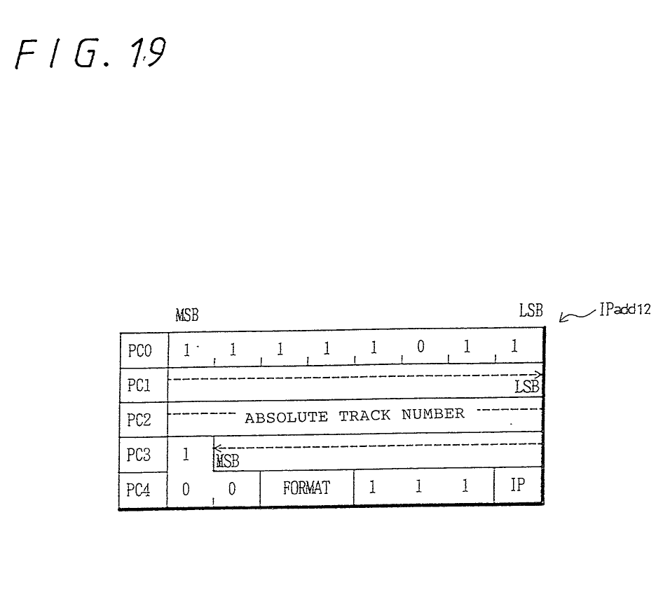

Next, by referring to FIG. 8 to FIG. 22, the data recorded in the attached memory 16 to the cassette will be described. First, FIG. 8 shows the structure of a pack as a unit of data recorded in the attached memory 16 to the cassette. This pack is composed of 5 bytes, and has a pack header 51 of 1 byte and a data section 52 of 4 bytes. The contents of the pack header 51 are different dependent on the type of the command. Furthermore, in the figure, the LSB shows the least significant bit and the MSB expresses the most significant bit.

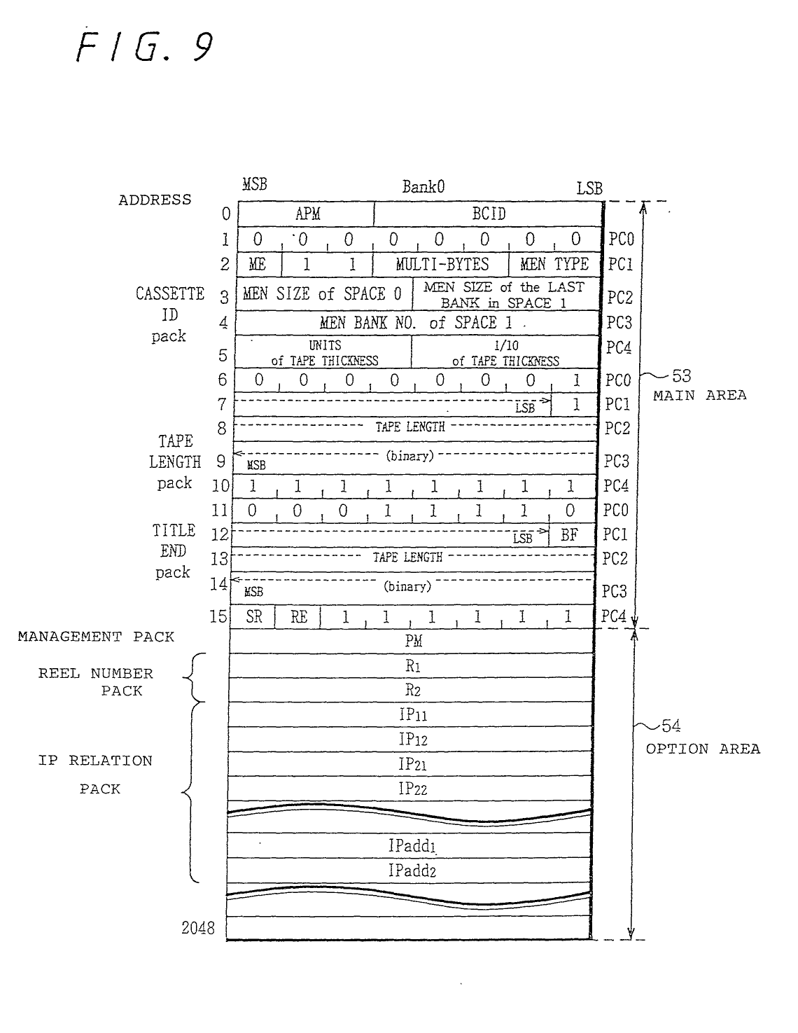

FIG. 9 shows the data format of the attached memory 16 to the cassette. This data format has a main area 53 and an option area 54. Since the contents of the main area 53 are not directly related to the present invention, the description thereof will be omitted. Furthermore, the format shown in FIG. 9 is specified in “Specifications of Consumer-Use Digital VCRs using 6.3 mm magnetic tape” (alias Blue Book).

The information related to the digital video cassette or the index picture is recorded in the option area 54 at the pack (hereafter, referred to as an IP relation pack)unit. In the present embodiment, a management pack PM including the management information such as a maker code or the total number of option packs to be described later on, is specified. Furthermore, as the packs related to the management of the digital video cassette 12, reel number packs R1, R2 indicating the reel number (cassette number), are specified, and as the IP relation packs, packs I Pn1, I Pn2 (n=1, 2, . . . ; n is incremented according to the change-over of the scene or take) related to the information such as the mark-in, the mark-out or the like, packs I Pabb1, I Pabb2, and CUEn related to the information for specifying the address (recording position) on the video tape 27 of the index picture information as the picture information of an index picture set screen, and a pack related to the address information on the video tape 27 at the time of pressing of the cue point by the user, are specified. Furthermore, in the present embodiment, the content of the pack header of the management pack is made to be “F0h”, and the content of the pack header of the reel number pack and the IP relation pack is made to be “FBh”.

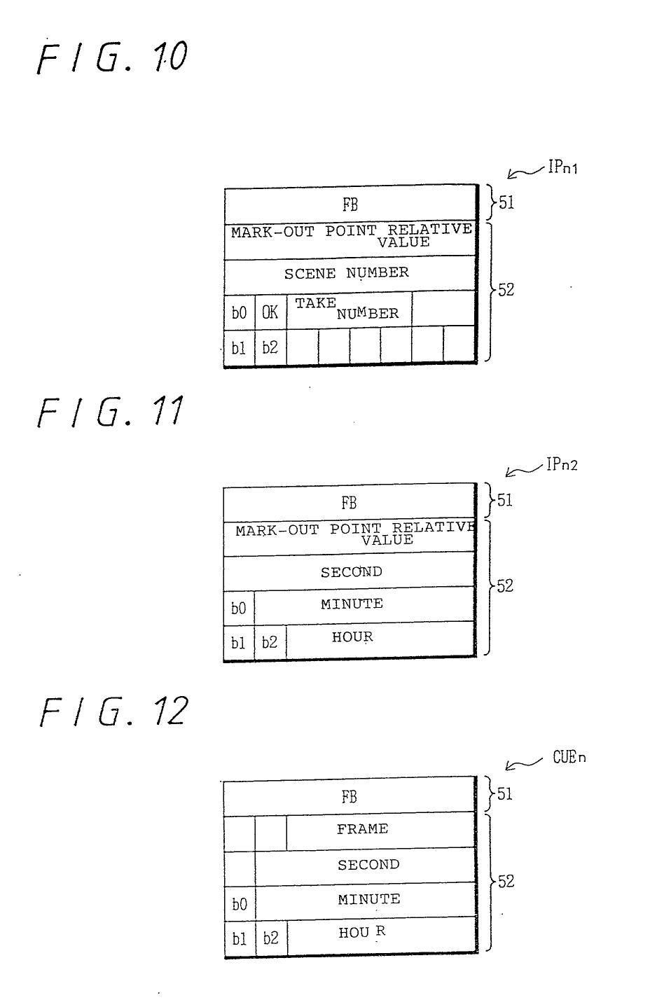

In FIG. 10 to FIG. 14, the outlines of the contents of the IP relation packs I Pn1, I Pn2, IP add2 are shown, respectively. Each is composed of a header section 51 and a data section 52.

FIG. 10 shows the outline of the contents of the pack I Pn1. In this pack I Pn1, it is arranged that in the data section 52, a flag (in FIG. 10, noted “OK”) indicating the upper 1 byte of the relative value of the mark-out point, the scene number, the take number, and the OK/NG, is recorded. FIG. 11 shows the outline of the contents of the pack I Pn2. In this pack I Pn2, it is arranged that in the data section 52, the lower 1 byte of the relative value of the mark-out point and the time code (hour, minute, second)of the mark-in point are recorded. Here, the time code means the inherent positional information (time information)at every frame recorded on a tape.

The relative value of the mark-out point shows the relative value of the time code from the mark-in point of the mark-out point, and is arranged to be indicated by the total of 2 bytes of the upper 1 byte in the pack I Pn1 and the lower 1 byte in the pack I Pn2. It is arranged that the maximum value of the scene number is 999 and the maximum value of the take number is 15. It is arranged that in the flag showing the OK/NG, “1” indicates OK and “0” indicates NG.

FIG. 12 shows the outline of the contents of the pack CUEn. In this pack CUEn, it is arranged that in the data section 52, the time code (hour, minute, second, frame) of the cue point is recorded.

FIG. 13 shows the outline of the contents of the pack I Padd1. In this pack I Padd1, it is arranged that in the data section 52, the time code (hour, minute, second, frame) indicating the recording position of the index picture information on the video tape 27 is recorded. FIG. 14 shows the outline of the contents of the pack I Padd2. In this pack I Padd2, it is arranged that in the data section 52, for the relief at the time of overlapping of the time code, an absolute track number indicating the recording position of the index picture information on the video tape 27 is recorded.

Furthermore, in FIG. 10 to FIG. 14, 3 bits noted as b2, b1, b0 are used as the sub header, and when b2, b1, b0 are 0, 0, 0, to be the pack I Padd1 is expressed, and when they are 0, 0, 1, to be the pack I Padd2 is expressed, and when they are 0, 1, 0, to be the pack I Pn1 is expressed, and when they are 0, 1, 1, to be the pack I Pn2 is expressed, and when they are 1, 0, 0, to be the pack CUEn is expressed.

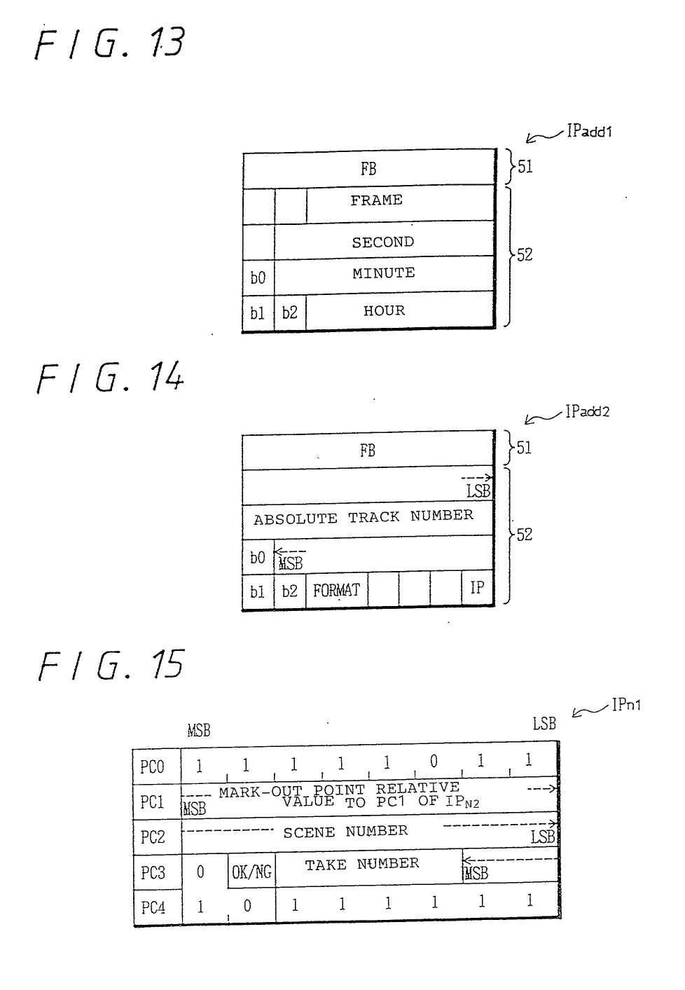

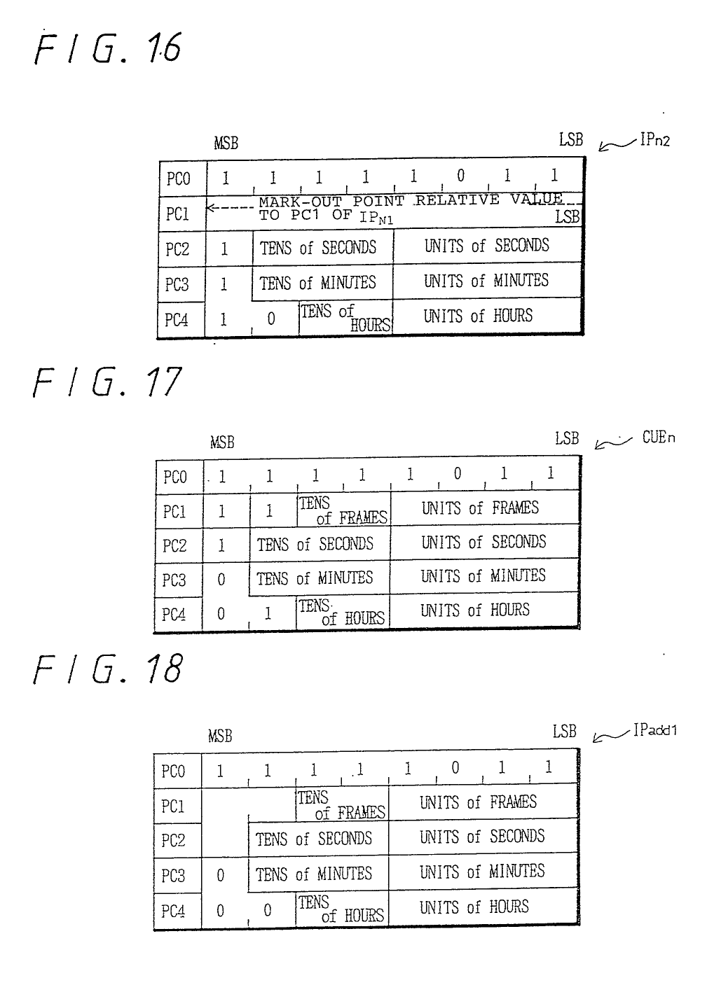

FIG. 15 to FIG. 19 show the detailed contents of the packs I Pn1, I Pn2, CUEn, I Padd1, I Padd2, respectively. Each has a specified value inserted into each specified position of the header section and the data section, and in FIG. 16 to FIG. 18, TENS of FRAMES expresses a value of frames at 10 column, UNITS of FRAMES expresses a value of frames at 1 column, TENS of SECONDS expresses a value of seconds at 10 column, UNITS of SECONDS expresses a value of seconds at 1 column, TENS of MINUTES expresses a value of minutes at 10 column, UNITS of MINUTES expresses a value of minutes at 1 column, TENS of HOURS expresses a value of hours at 10 column, and UNITS of HOURS expresses a value of hours at 1 column.

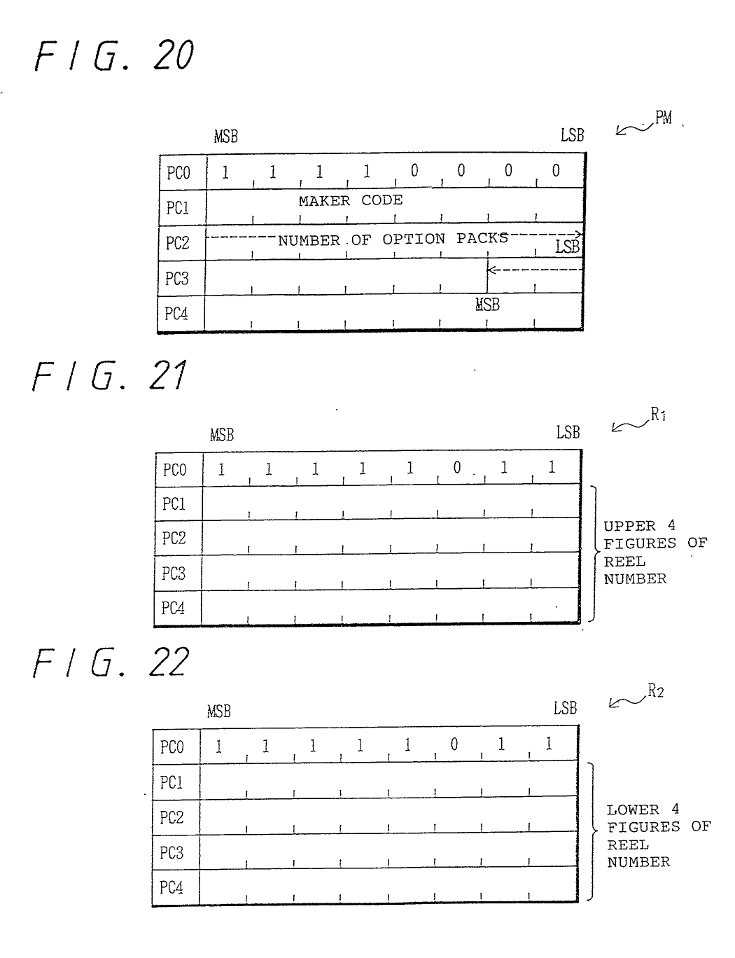

FIG. 20 to FIG. 22 show the detailed contents of a management pack PM, and reel number packs R1, R2, respectively. Similarly to the detail of each pack shown in FIG. 15 to FIG. 19, each pack is composed of a header section and a data section, and each has a specified value inserted into a specified position. In the management pack PM in FIG. 20, a maker code indicates whether the data recorded in the pack following this management pack PM is an original code of either of the makers, and the number of option packs indicates the total number of packs specified in the option area 54 shown in FIG. 9, following that. In the reel number packs R1, R2 shown in FIG. 21 and FIG. 22, the 4 bytes of the data section of the reel number pack R1 in FIG. 21 show the upper 4 figures of the reel number, and the 4 bytes of the data section of the reel number pack R2 in FIG. 22 show the lower 4 figures of the reel number. The reel number is expressed by 8 figures of alphanumeric characters.

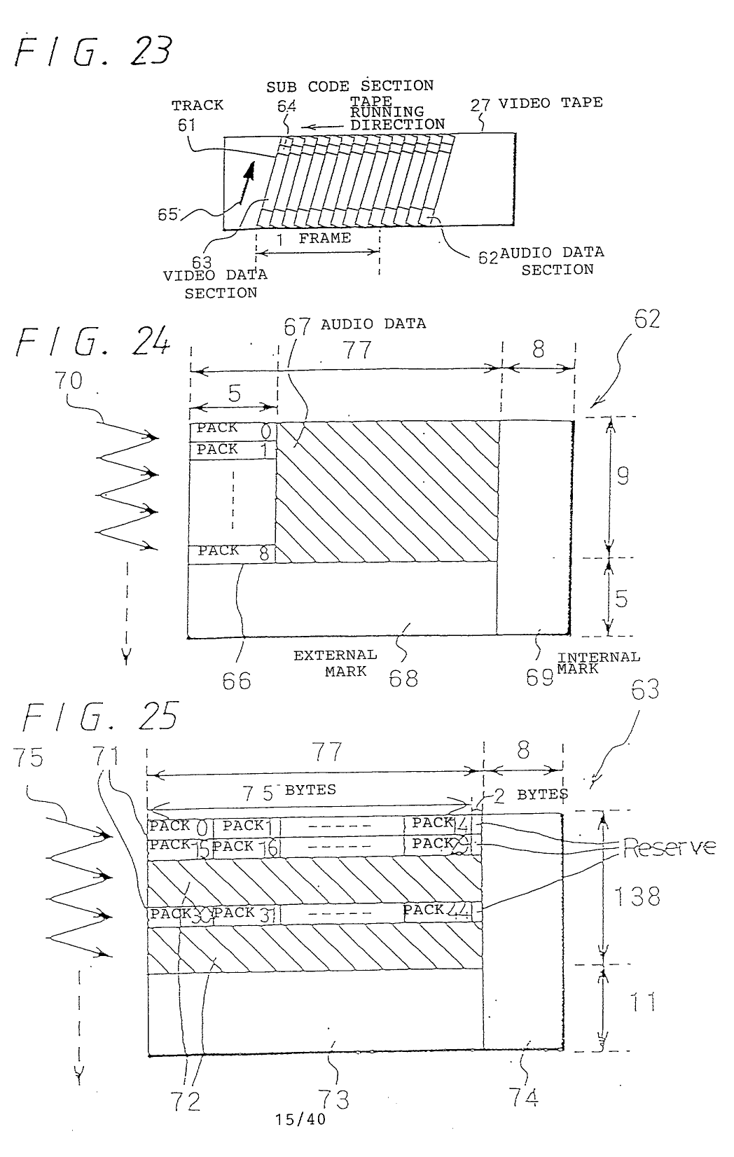

Next, by referring to FIG. 23 to FIG. 30, the data recorded on the video tape 27 will be described. Here, the description will be given, supposing that an NTSC signal is recorded and reproduced. FIG. 23 shows a recording pattern on the video tape 27. On the video tape 27, 1 frame is composed of 10 tracks. Each track 61 has an audio data section 62, a video data section 63, and a sub code section 64. Furthermore, in the figure, the arrow shown by reference numeral 65 expresses the running direction of the head, that is, the order of recording and reproduction of the data.

FIG. 24 shows the data structure for 1 track amount recorded in the audio data section 62 in FIG. 23. In the audio data section 62, data are recorded, which are arranged such that an external code of 77×5 bytes is added to a block of 77×9 bytes composed of audio auxiliary data 66 of 5×9 bytes and audio data 67 of 72×9 bytes, and an internal code 69 of 8×14 bytes is further added to that. In the figure, the arrow shown by reference numeral 70 indicates the direction of recording and reproduction. Here, the audio auxiliary data recorded in the audio auxiliary data 66 are auxiliary data such as the sampling frequency of the audio data, the number of quantized bits, year, month, day of recording, and hour, minute, second of recording and so on. These auxiliary data are recorded at positions (for amount of 6 packs) having previously determined pack numbers in each pack of the auxiliary data area, and in a case where the user wants to originally record the management information, recording for 3 packs besides that (actually, 12 bytes except for the pack header) is possible. For example, in the audio data of sampling frequency of 48 kHz, 16 bits, the data for the first channel are interleaved and recorded in the first half for 5 tracks of 1 frame (10 tracks), and the data for the second channel are interleaved and recorded in the rest second half for 5 tracks.

FIG. 25 shows the data structure for 1 track amount recorded in the video data section 63 in FIG. 23. As shown in FIG. 25(a), in the video data section 63, data are recorded, which are arranged such that an external code 73 of 77×11 bytes is added to a block of 77×138 bytes composed of video auxiliary data 71 of 77×(2+1) bytes and video data 72 of 77×135 bytes, and an internal code 74 of 8×149 bytes is further added to that. In the figure, the arrow shown by reference numeral 75 shows the direction of recording and reproduction. Here, the video auxiliary data recorded in the video auxiliary data area are data such as the system of television broadcasting, the television channel, (year, month, day) of recording, hour, minute, second of recording and so on. As shown in FIG. 25(b), these auxiliary data are inserted into positions (for amount of 6 packs similarly to the audio auxiliary data) having previously determined pack numbers in each pack of the auxiliary data area 71, and when the user wants to originally insert auxiliary data, the insertion into the positions (for 39 packs, amount of 156 bytes) except for the determined positions is possible.

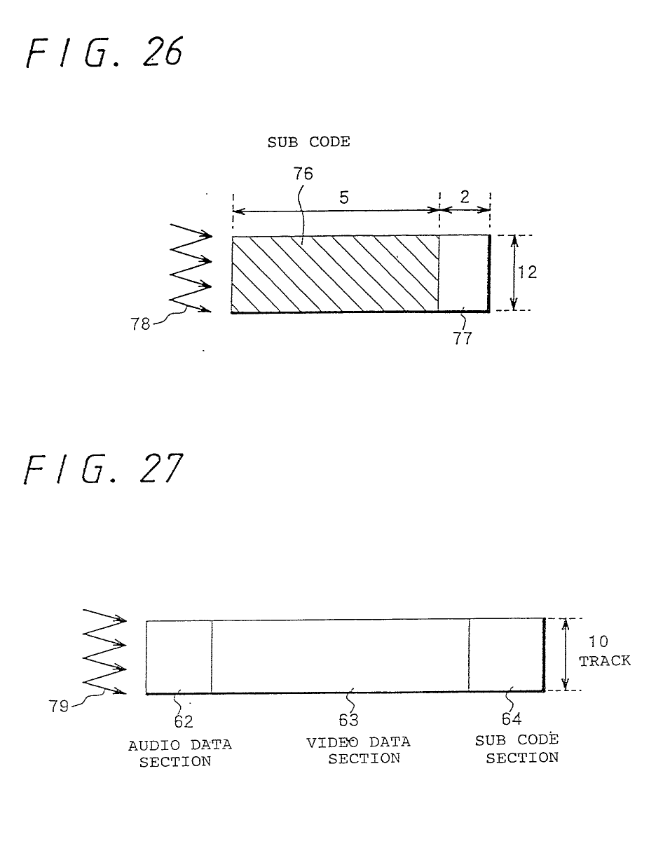

FIG. 26 shows the data structure recorded in the sub code section 64 in FIG. 23. In the sub code section 64, data arranged by adding an internal code 77 of 2×12 bytes to a sub code 76 of 5×12 bytes are recorded. In the figure, the arrow shown by reference numeral 78 indicates the direction of recording and reproducing. The sub code recorded in the sub code section 64 is the data indicating the picture and voice management information such as the absolute track number and so on to perform the heading at a high speed. In the sub code section 64, available areas are also ensured similarly to the video and audio auxiliary data areas 71, 66, and the recording for 6 pack (for 2 bytes except for the pack header) amount is possible.

FIG. 27 shows the arrangement of the audio data section 62, the video data section 63, and the sub code section 64 on the video tape 27. In the figure, the arrow shown by reference numeral 79 shows the direction of recording and reproduction. As shown in this figure, on the video tape 27, the sections are arranged in the order of the audio data section 62, the video data section 63, and the sub code section 64 in the direction of recording and reproduction.

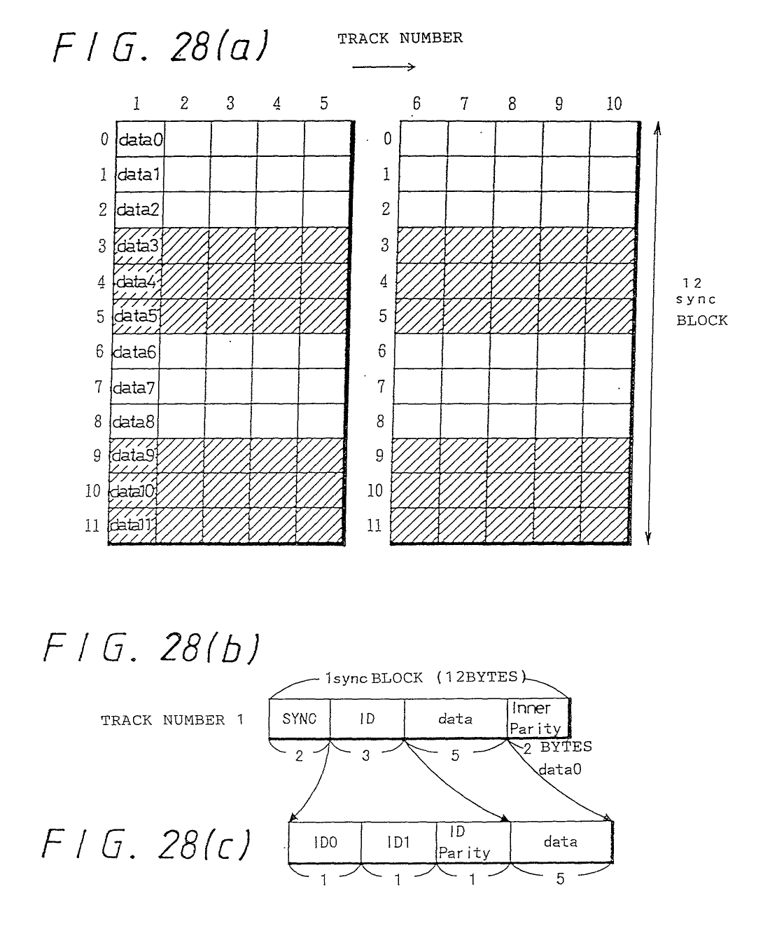

FIG. 28 shows the details of the sub code section 64 on the track 61 shown in FIG. 23. FIG. 28(a) shows the physical arrangement of the sub code section. In the figure, the blank part with no slanting line shows the portion open to the user. The numbers shown in the horizontal direction indicate the track numbers on the track, and the total of FIG. 28(a) shows the sub code section 64 recorded in 1 frame. Furthermore, each block is divided into 12 sync blocks as numbers are given in the figure, and the data structure of 1 measure is shown in FIG. 12(b).

As shown in FIG. 28(b), 1 measure is composed of 1 sync block, 12 bytes, and is divided into a sync code area of 2 bytes, an ID area of 3 bytes, a data area of 5 bytes, and an inner parity area of 2 bytes. Into the sync code area, the code of each sync block is inserted, and into the ID area, the data including the absolute track number are inserted, and into the data area, the sub code data are inserted, and into the inner parity area, the inner parity at every block is inserted.

FIG. 28(c) shows the arrangements of the ID area and the data area. The ID area of 3 bytes is divided into ID areas ID0, ID1 each of which is 1 byte and an ID parity area of 1 byte.

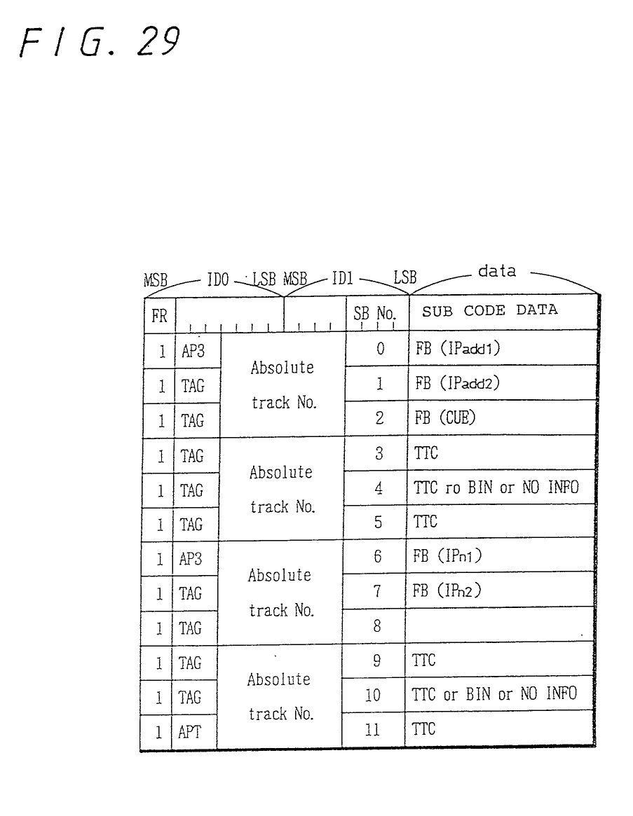

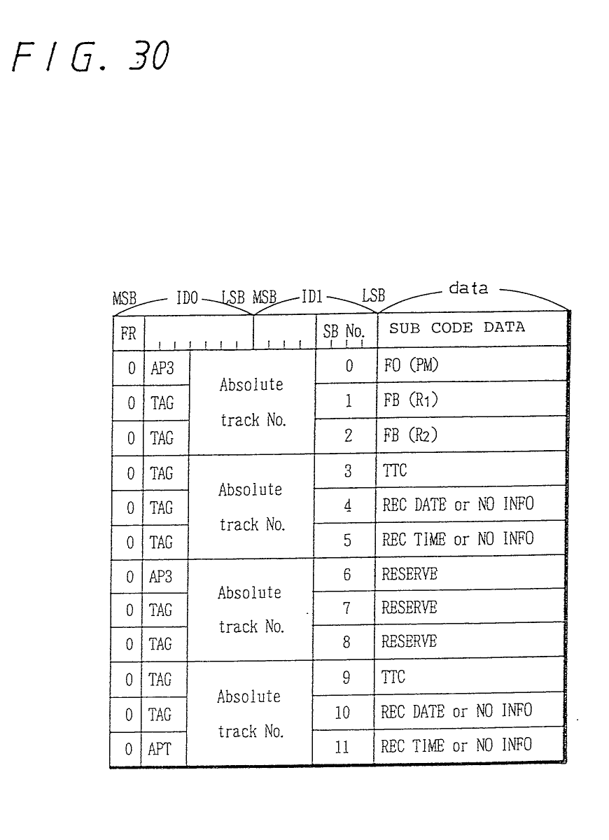

FIG. 29 and FIG. 30 show the details of the actual data inserted into the ID areas ID0, ID1 and the data area. FIG. 29 shows the details of the data recorded in the sub code section 64 of the first half 5 tracks, and FIG. 30 shows the details of the data recorded in the sub code section 64 of the second half 5 tracks. However, as shown in FIG. 28(c), the ID parity area of 1 byte inserted into the ID area is eliminated. Accordingly, FIG. 29 and FIG. 30 show the data structure of each track in FIG. 28(a) eliminating the parity area shown in FIG. 28(c).

In FIG. 29, as the data arranged in the area of 4 bits on the SB side of ID0×12 sync blocks (in the horizontal direction) and 4 bits on the LSB side of ID1×12 sync blocks (in the horizontal direction), previously determined data are arranged, respectively, and therefore, here, the description thereof will be omitted. In the right 4 bits of ID0 and the left 4 bits of ID1, as the absolute value number of each track, the same absolute value number is recorded continuously in 4 blocks, for each 3 sync blocks. In the sub code area, the above-said packs I Pn1, I Pn2, CUEn, I Padd1, I Padd2 are recorded in the blocks corresponding to the blank area of FIG. 28(a). In FIG. 28, each is arranged as FB (I Pn1), FB (I Pn2), FB (CUEn), FB (I Padd1), FB(I Padd2). Into the sub code area other than that, as shown by the slanting lines in FIG. 28(a), previously determined data are inserted. Here, the description thereof will be omitted.

In FIG. 30, similarly to FIG. 29, as the data arranged in the area of 4 bits on the MSB side of ID0×12 sync blocks (in the vertical direction) and 4 bits on the LSB side of ID1×12 sync blocks (in the vertical direction), previously determined data are arranged, and therefore, here, the description thereof will be omitted. Furthermore, in the area similar to that in FIG. 29, the absolute track numbers are recorded. In the blank areas of FIG. 28(a) of the sub code area, the management pack PM, the reel number packs R1, R2 are recorded. In the figure, each is noted as FO (PM), FB (R1), FB (R2).

[Production of the Index Picture Information]

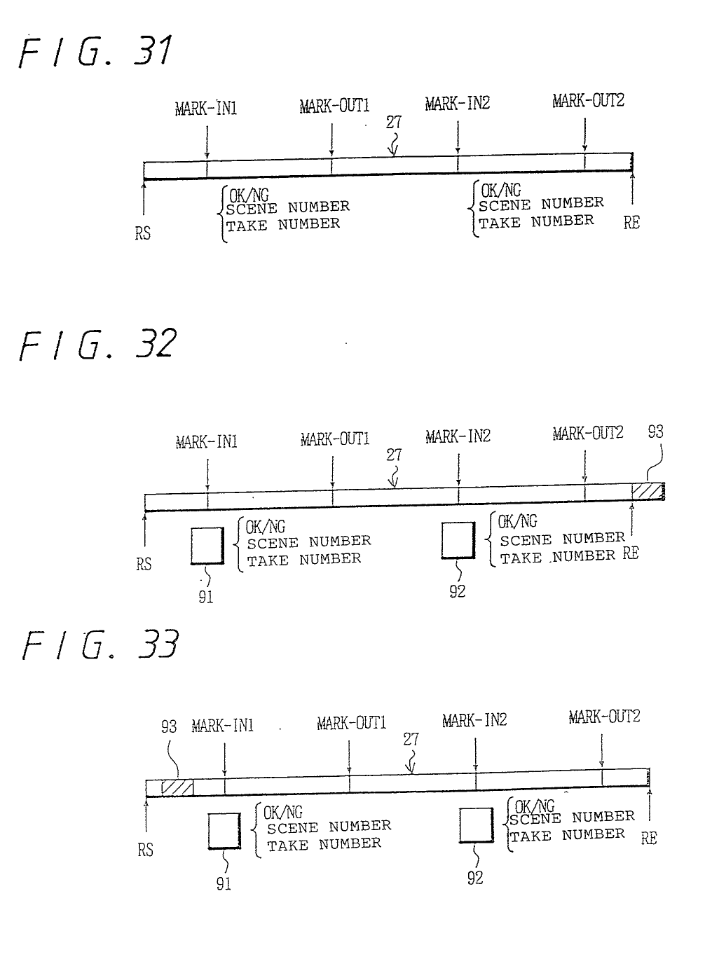

Next, by referring to FIG. 31 to FIG. 35, the action related to the production of the index picture information in the system shown in FIG. 1 and the index picture production method according to the present embodiment will be described.

First, the action in the case of instructing the mark-in point, the mark-out point, the OK/NG, the take number and the like by using the operational section 33 when recording the picture information on the video tape 27 by the digital VTR section 20 shown in FIG. 2, will be described. When recording the picture information on the video tape 27 by the digital VTR section 20 shown in FIG. 2, the video signal from the digital video camera section is inputted into the digital VTR section 20 through the input terminal 21. This video signal is subjected to A/D conversion by the A/D converter 22, and is subjected to compression coding by the video signal compression coding.decoding section 23, and an error correction code is added thereto by the error correction processing section 24, and coding processing suitable for recording that on a video tape is performed by the channel coding section 25, and the video signal is recorded on the video tape 27 by the video head 26.

At the time of such recording, if the user selects the mark mode, and instructs the mark-in point, the mark-out point, the OK/NG, and the take number by using the operational section 33, the instructed information and the information of the automatically incremented scene number are recorded in the option area 54 of the attached memory 16 to the cassette in the digital video cassette 12 and the sub code section 64 of the video tape 27, by the controller 35. The recording into the option area 54 of the attached memory 16 to the cassette is performed by such an action that the controller 35 transmits the data to the attached memory 16 to the cassette through the terminals 34, 15, and the recording into the sub code section 64 of the video tape 27 is performed by such an action that the controller 35 sends the data to the channel coding section 25. Furthermore, the information of the mark-in point, the mark-out point, the OK/NG, the take number, and the scene number is recorded by the packs I Pn1, I Pn2 shown in FIG. 10, FIG. 11, FIG. 15, and FIG. 16. Furthermore, at the time of selecting the cue mode, the information start time and the picture taking end time of each scene are automatically made to be the mark-in point and the mark-out point, and the information thereof is recorded in the attached memory 16 to the cassette and on the video tape 27, and when the cue point is indicated by the operational section 33, the information thereof is recorded in the option area 54 of the attached memory 16 to the cassette and on the video tape 27 by the pack CUEn shown in FIG. 12 and FIG. 17.

FIG. 31 schematically shows the state of the video tape 27 at the time of specifying a pair of mark-in point and mark-out point at 2 places when recording the above mentioned picture information. In this figure, RS expresses the recording start point, RE expresses the recording end point, MARK-IN 1 expresses the first mark-in point, MARK-OUT 1 expresses the first mark-out point, MARK-IN 2 expresses the second mark-in point, and MARK-OUT 2 expresses the second mark-out point. To each of the first recording material between the first mark-in point and the first mark-out point, and the second recording material between the second mark-in point and the second mark-out point, the additional information of the OK/NG, the take number, and the scene number is added.

Up to now, a case where the mark-in point and the like are indicated at the time of recording of the picture information, has been described, but in the present embodiment, it is also possible to indicate the mark-in point and the like by using the operational section 33, when reproducing the picture information recorded on the video tape by the digital VTR section 20 or the digital video cassette recorder 13 shown in FIG. 3. In this case, when indicating the mark-in point and the like, the user may operate the operational section 33 after once stopping the reproduction at a target scene, or may operate the operational section 33 at the target scene while continuing the reproduction. The method to record the additional information such as the mark-in point and so on indicated at the time of reproducing the picture information into the attached memory 16 to the cassette and on the video tape 27, is similar to that at the time of recording the picture information. Furthermore, when reproducing the picture information, the signal recorded on the video tape 27 is reproduced by the video head 26, and decoded by the channel coding section 25, and is subjected to the error correction processing by the error correction processing section 24, and is decoded by the video signal compression coding.decoding section 23, and is subjected to the D/A conversion by the D/A converter 28, and is outputted from the output terminal 29.

Next, such an action that while the picture information is recorded on the video tape 27 as mentioned above, the index picture information is produced and recorded on the video tape 27, by using the digital video cassette 12 having the attached memory 16 to the cassette and the video tape 27 in which the additional information such as the mark-in point or the like is recorded, will be described by referring to FIG. 32. FIG. 32 typically shows the state of the video tape 27 at the time of producing the index picture information. Production of the index picture information is performed by the digital video cassette recorder 13 shown in FIG. 3. When the user instructs the production of the index picture information by using the operational section 33, the controller 35 of the digital video cassette recorder 13 reads out the information of all the mark-in points, that is, the time code from the attached memory 16 to the cassette, and controls the mechanical section 31, and makes the video tape 27 pre-roll to the pre-roll point for the first mark-in point. After that, the controller 35 performs such a control that the picture of the first mark-in point, that is, an index picture 91 may be reproduced, and that the decoded index picture 91, which is decoded through the channel coding section 25, the error correction section 24 and the video signal compression coding.decoding section 23, may be sent to the index producing section 40, and that it may be stored in the index memory 41. Next, the controller 35 performs such a control that the picture at the second mark-in point, that is, an index picture 92 may be reproduced, and that the decoded index picture 92, which is decoded through the channel coding section 25, the error correction section 24 and the video signal correction compression coding.decoding section 23, may be sent to the index producing section 40, and that it may be stored in the index memory 41. As for the third and afterward mark-in points, the control is similar.

Furthermore, the index producing section 40 sends the taken-in index picture to the video signal compression coding•decoding section 23 for compression and reduction. The video signal compression coding.decoding section 23 performs a DCT processing onto the sent signal at a block unit of a specified size, and sends the DC (direct current) component with the block section to the index producing section 40. The index producing section 40 produces a compressed and reduced index picture by using the DC component at every block, and stores the data of this compressed and reduced index picture at a position of a specified address in the index memory 41, and produces the index picture information as the picture information of the set screen of the compressed and reduced index picture (that is, the simple index picture). When the index producing section 40 has stored the data of the compressed and reduced index picture by a specified capacity amount assigned to the index picture information to the index memory 41, the controller 35 changes over the switch 39, and outputs the index picture information from the index producing section 40, and inputs the same through the switch 39 into the video signal compression coding.decoding section 23, and controls the mechanical section 31 so that the state may be a state capable of recording the signal at a specified position (for example, after the recording end point RE or after the recording start point RS) of the video tape 27. The index picture information outputted from the index producing section 40 is compressed and coded by the video signal compression coding.decoding section 23, and is subjected to a specified processing in the error correction processing section 24 and the channel coding section 25, and is recorded at a specified position of the video tape 27 by the video head 26.

FIG. 32 shows an example in which an index picture information 93 is continuously recorded after the recording end point RE. Furthermore, FIG. 33 shows an example in which the index picture information 93 is continuously recorded after the recording start point RS, after producing the index picture information similarly to the example of FIG. 32. By the way, after the recording start point RS, a black signal is recorded originally for several seconds, and even if the index picture information 93 is recorded in this position, the picture information is not broken.

When the index picture information 93 has been recorded on the video tape 27, the controller 35 records the time code of the recording position on the video tape 27 of the index picture information 93 into the option area 54 of the attached memory 16 to the cassette by using the packs I Padd1, I Padd2, and also records that in the sub code section 64 at a specified position (for example, a position equal to the recording position of the index picture information 93 or a position near the position) of the video tape 27.

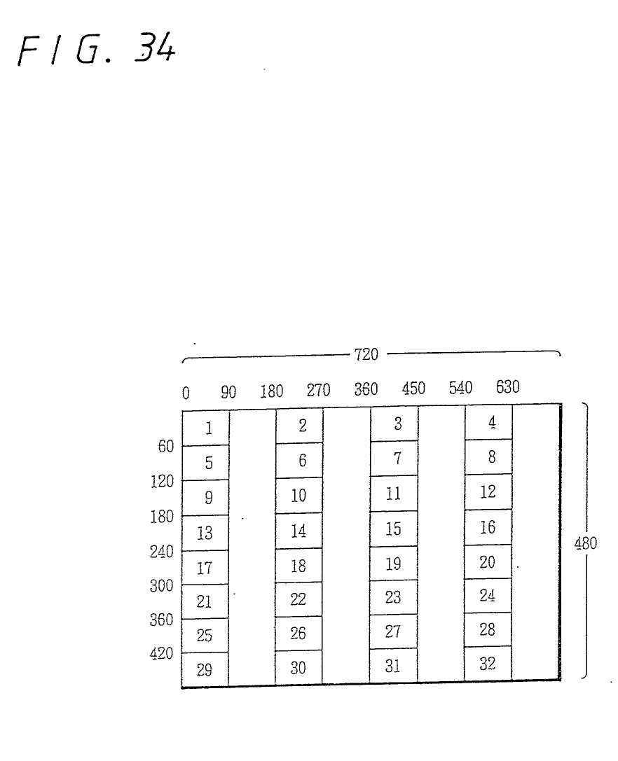

FIG. 34 is an explanatory diagram for describing one example of a picture displayed by the index picture information. This example is an example of NTSC system, and in 1 frame of 720 dots×480 lines, 32 pieces of simple index pictures at maximum are arranged. Furthermore, in the figure, each of the parts having the numerals 1 to 32 expresses a simple index picture, and it is arranged that the simple index pictures are recorded according to the order of time (order of increasing the time code), and the numerals 1 to 32 in the figure are recorded in that order.

Furthermore, until now, the case where the picture of each mark-in point is made to be an index picture unconditionally, has been described, but in the present embodiment, it is also possible that a picture agreeing with a desired condition among the pictures of respective mark-in points, is selected and made to be an index picture, on the basis of the information of the OK/NG, the take number, and the scene number as the additional information.

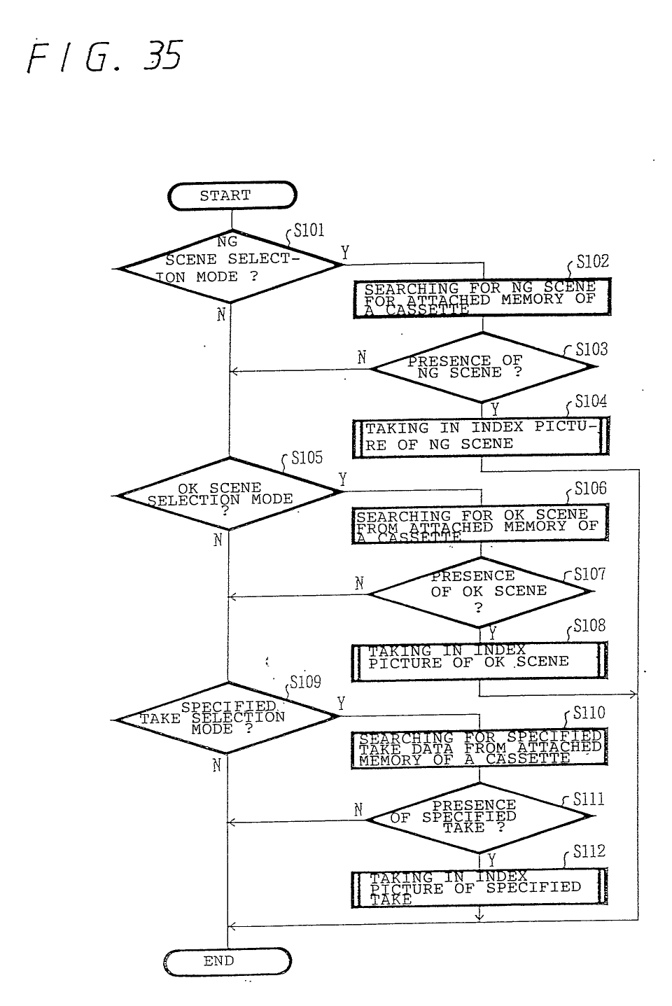

FIG. 35 is a flow chart showing the action of the controller 35 in the case of selecting the index picture on the basis of the information of the OK/NG and the take number. In this example, the NG scene selection mode selecting only the NG scene, the OK scene selection mode selecting only the OK scene, and the specified take selection mode selecting only the take with a specified take number, are specified. These modes are arranged to be selected by the operation of the operational section 33 by the user. In the action shown in FIG. 35, the controller 35 first judges whether the mode is the NG scene selection mode or not (step S101). When the mode is the NG scene selection mode (Y), it searches for an NG scene from the attached memory 16 to the cassette (step S102). Specifically, it checks in turn the flags showing the OK/NG in the pack I Pn1 recorded in the option area 54 of the attached memory 16 to the cassette. Next, the controller 35 judges whether there is an NG scene or not (step S103), and if there is an NG scene (Y), it takes in the picture of the mark-in point in the NG scene as an index picture (step S104), and finishes the action to select the index picture.

In the case where the mode is not the NG scene selection mode (step S101; N) and in the case where there is no NG scene (step S103; N), the controller 35 judges whether the mode is the OK scene selection mode or not (step S105). In the case where the mode is the OK scene selection mode (Y), it searches for an OK scene from the attached memory 16 to the cassette (step S106). Specifically, it checks in turn the flags showing the OK/NG in the pack I Pn1 recorded in the option area 54 of the attached memory 16 to the cassette. Next, the controller 35 judges whether there is an OK scene or not (step S107), and if there is an OK scene (Y), it takes in the picture of the mark-in point in the OK scene as an index picture (step S108), and finishes the action to select the index picture.

In the case where the mode is not the OK scene selection mode (step S105; N) and in the case where there is no OK scene (step S107; N), the controller 35 judges whether the mode is the specified take selection mode or not (step S109). In the case where the mode is the specified take selection mode (Y), it searches for specified take data from the attached memory 16 to the cassette (step S110). Specifically, it checks in turn the take numbers in the pack I Pn1 recorded in the option area 54 of the attached memory 16 to the cassette, and extracts a take number agreeing with the specified take number. Furthermore, the specifying of the take number is arranged to be performed by the operation of the operational section 33 by the user. Next, the controller 35 judges whether there is a specified take or not (step S111), and if there is a specified take (Y), it takes in the picture of the mark-in point in the specified take as an index picture (step S112), and finishes the action of the selection of the index picture. In the case where the mode is not the specified take selection mode (step S109; N) and in the case where there is no specified take (step S111; N), the controller 35 finishes the action of the selection of the index picture.

Furthermore, in the example shown in FIG. 32, a case of selecting an index picture by specifying the scene number is shown, and this can be realized similarly to the case of selecting an index picture by specifying the take number.

Furthermore, until now, the case where the picture of each mark-in point is made to be an index picture, has been described, but it is also possible that a picture of each cue point is made to be an index picture. In this case, index pictures are produced as for the pictures of all cue points and are recorded in specified places of the video tape 27, on the basis of the time code of the pack CUEn recorded in the option area 54 of the attached memory 16 to the cassette.

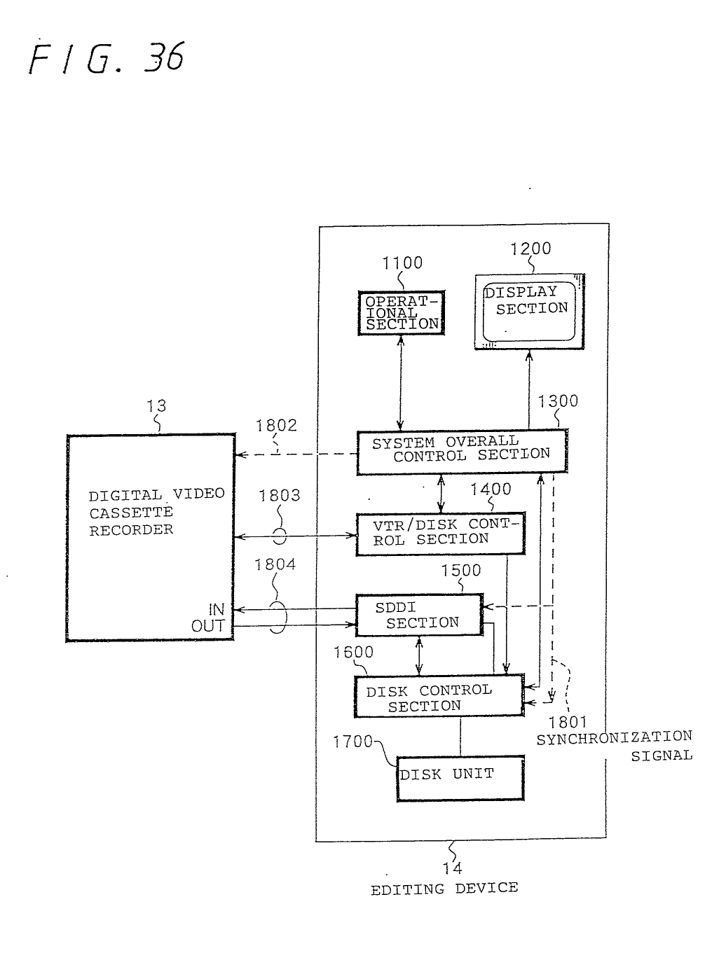

Next, by referring to FIG. 36 to FIG. 54, the arrangement and the action of the editing device 14 will be described.

[Arrangement of the Editing Device 14]

First, by referring to FIG. 36 to FIG. 40, the arrangement of the editing device 14 will be described. FIG. 36 shows the rough arrangement of the editing device 14 in FIG. 1 and the connecting relation between this editing device 14 and the digital video cassette recorder 13. As shown in this figure, the editing device 14 comprises: an operational section 1100 composed of a mouse, a key board, and the like; a display section 1200 composed of a CRT display device and the like; a system overall control section 1300 connected to the operational section 1100 and the display section 1200; a VTR/DISK control section 1400 connected to the system overall control section 1300; a serial.digital.data interface (SDDII/F) 1500; a disk control section 1600 connected to the system overall control section 1300, the VTR/DISK control section 1400, and the SDDI section 1500; and a disk unit 1700 connected to the disk control section 1600.

The operational section 1100 is a part to be operated when performing the work such as recording, reproduction, and editing relative to the digital video cassette 12 set in the digital video cassette recorder 13, and the display section 1200 is a part for displaying a picture screen necessary for performing such works. Various types of commands given from the operational section 1100 are sent to the VTR/DISK control section 1400 through the system overall control section 1300, and here, are converted into a form suited to the signal format on a signal cable 1803, and are sent to the digital video cassette recorder 13 to thereby control the same. The system overall control section 1300 supplies a synchronization signal 1801 to the VTR/DISK control section 1400, the SDDI section 1500, and the digital control section 1600 and performs the synchronization control of the whole of the editing device 14, and at the same time, supplies a synchronization signal 1802 to the digital video cassette recorder 13. The VTR/DISK control section 1400 sends and receives, to and from the digital video cassette recorder 13 through the control signal cable 1803, the control command, the above mentioned IP relation information (the mark-in point, the mark-out point, the cue point, the OK/NG, and the like), and the tape management information (reel number and the like), and performs the control of the disk control section 1600, too.

The SDDI section 1500 is a part functioning as a data interface between the digital video cassette recorder 13 and the disk control section 1600, and has a function to convert the signal format of the data (video data, audio data, and the sub code) sent on an SDDI cable 1804 from the digital video cassette recorder 13 and to send the same to the disk control section 1600, and at the same time, to convert the signal format of the data from the disk control section 1600 and to send the same to the digital video cassette recorder 13 by the SDDI cable 1804. In the video data, the index picture information is also included besides the picture materials. Here, the picture materials mean the video data and the audio data which are obtained at the time of picture taking of news gathering or drama producing and are left changed. The disk control section 1600 performs the control to carry out the operational control of the disk unit 1700 and to carry out recording and reproduction of the data to and from the disk unit 1700.

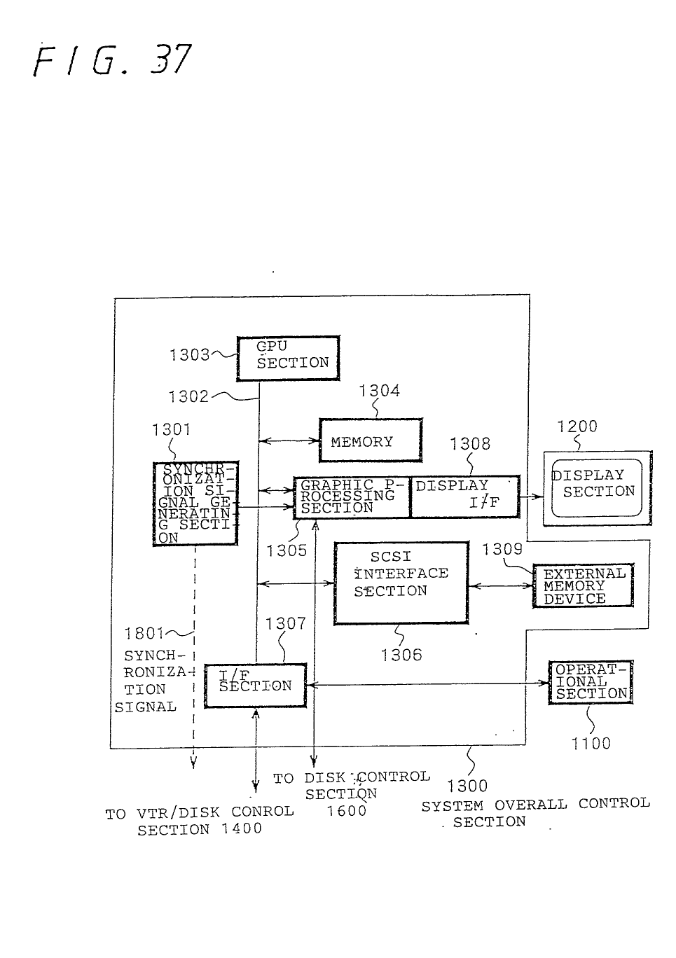

FIG. 37 shows the arrangement of the system overall control section 1300. As shown in this figure, the system overall control section 1300 comprises: a synchronization signal generating section 1301 for generating the synchronization signal 1801; a CPU section 1303, a memory 1304, a graphic processing section 1305, an SCSI (Small Computer System Interface) interface section 1306, and an interface (I/F) section 1307 which are mutually connected by an internal bus 1302; a display I/F 1308 connected to the graphic processing section 1305; and an external memory device 1309 connected to the SCSI interface section 1306.

As described later, the memory 1304 functions as a work memory when performing the editing work using an index picture. The SCSI interface section 1306 performs data format conversion between the same and the external memory device 1309, and the display I/F 1308 performs data format conversion between the same and the display section 1200. The I/F section 1307 performs the interface between the same and the operational section 1100 and the VTR/DISK control section 1400. The external memory device 1309 is a part to store the data (FIG. 9) read in from the attached memory 16 to the cassette of the digital video cassette 12 set in the digital video cassette recorder 13, and the index picture information (FIG. 34) read out from the disk unit 1700 and sent through the disk control section 1600. The graphic processing section 1305 is connected to the disk control section 1600, and performs sending and receiving of the index picture information. The information expressing each simple index picture displayed in the display section 1200 is converted into a form to be recorded on the video tape 27 at the graphic processing section 1305, and is outputted at the frame unit as the information of the set screen of simple index pictures (that is, the index picture information), and is transferred to the disk unit 1700 through the disk control section 1600.

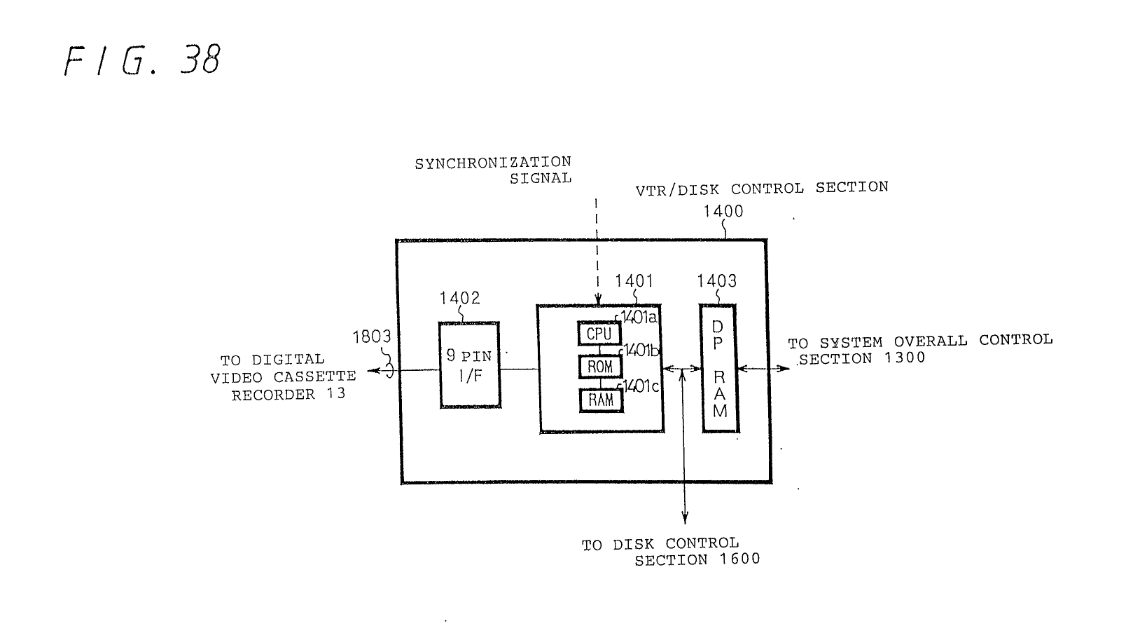

FIG. 38 shows the schematic arrangement of the VTR/DISK control section 1400. As shown in this figure, the VTR/DISK control section 1400 comprises: a main CPU section 1401 including a CPU 1401a, a ROM 1401b, a RAM 1401c, and a DPRAM (dual port-random access memory) I/F (not shown in the figure); and a control signal I/F 1402 and a DPRAM 1403 connected to the CPU section 1401. The control signal I/F 1402 is connected to the digital video cassette recorder 13 by the signal cable 1803 (FIG. 36), and the DPRAM 1403 is connected to the system overall control section 1300. The main CPU section 1401 is also connected to the disk control section 1600.

In the VTR/DISK control section 1400 arranged like this, when various types of commands or statuses are inputted from the system overall control section 1300, these are sent to the main CPU 1401 through the DPRAM 1403, and further, by the signal signal I/F 1402, they are converted into the formats capable of being transmitted through the signal cable 1803, and are sent out to the digital video cassette recorder 13 by the signal cable 1803 in synchronization with the synchronization signal 1802. Furthermore, the main CPU 1401 has such a function that when receiving a command from the system overall control section 1300, it converts the format thereof and sends the same to the disk control section 1600. When receiving a recording command or an assemble command from the system overall control section 1300, the main CPU section 1401 controls the digital video cassette recorder 13 so as to record that in the format shown in FIG. 29 and FIG. 30, on the video tape 27 from the present position.

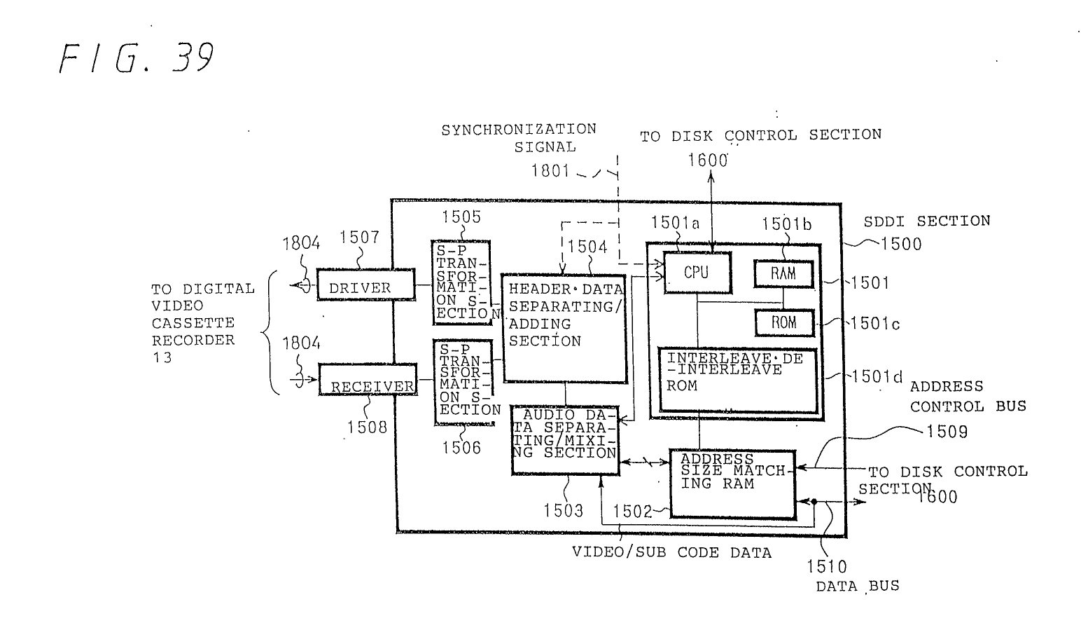

FIG. 39 shows the arrangement of the SDDI section 1500. As shown in this figure, the SDDI section 1500 comprises: a CPU section 1501 including a CPU 1501a, a RAM 1501b, a ROM 1501c and an interleave/de-interleave ROM 1501d; an address size matching RAM 1502 connected to the CPU section 1501; an audio data separating/mixing section 1503 connected to the CPU section 1501 and the address size matching RAM 1502; a header.data separating/adding section 1504 connected to the audio data separating/mixing section 1503; serial-parallel (S-P) conversion sections 1505, 1506 connected to the header-data separating/adding section 1504; and a driver 1507 and a receiver 1508 respectively connected to the S-P conversion sections 1505 and 1506.

To the CPU section 1501 and the header-data separating/adding section 1504, the synchronization signal 1801 is supplied, whereby the action of synchronization is performed therebetween. The CPU section 1501 is connected to the disk control section 1600, and the driver 1507 and the receiver 1508 are respectively connected to an input terminal IN and an output terminal OUT of the digital video cassette recorder 13 by the SDDI cables 1804. The address size matching RAM 1502 is connected to the disk control section 1600 by an address control bus 1509 and a data bus 1510.

In this SDDI section 1500, the SDDI data (video data.audio data, and the sub code) reproduced in the digital video cassette recorder 13 and transferred in serial transmission fashion from the output terminal OUT thereof on the SDDI cable 1804 are received by the receiver 1508, and further, are converted into parallel data by the S-P conversion section 1506 and then are inputted into the header-data separating/adding section 1504. In this header-data separating/adding section 1504, separation of the header section and the data section is performed, and further, in the audio data separating/mixing section 1503, audio data are extracted from the data section, and the audio data inserted into the data section, and the video data and sub code are separated. While referring to the interleave/de.interleave ROM 1501d, the CPU 1501a performs de-interleave processing to the extracted audio data, and writes the same into the address size matching RAM 1502. The audio data written in the address size matching RAM 1502 are further transferred to the disk control section 1600 by the address control bus 1509 and the data bus 1510. Furthermore, the audio data and the sub code separated in the audio data separating/mixing section are transferred to the disk control section 1600 from the data bus 1510 without passing through the address size matching RAM 1502.

In contrast with this, the data from the disk control section 1600 are once written in the address size matching RAM 1502. The CPU 1501a measures the necessary amount of data, in the period of being measured by the synchronization signal (frame pulse), and subjects the same to a specified amount of interleave following the previous frame, and sends the audio data to the audio data separating/mixing section 1503. Furthermore, the video data and the sub code are directly transferred to the audio data separating/mixing section 1503 from the data bus 1510 without passing through the address size matching RAM 1502. In the audio data separating/mixing section 1503, mixing of the audio data and the video data is performed, and further, in the header-data separating/adding section 1504, the header section is added. The data to which the header section is added, are converted into the serial data in the S-P conversion section 1505, and are sent out from the driver 1507 as the SDDI data (video data, audio data and the sub code). The SDDI data are sent on the SDDI cable 1804 in the serial transfer fashion, and are inputted into the input terminal IN of the digital video cassette recorder 13.

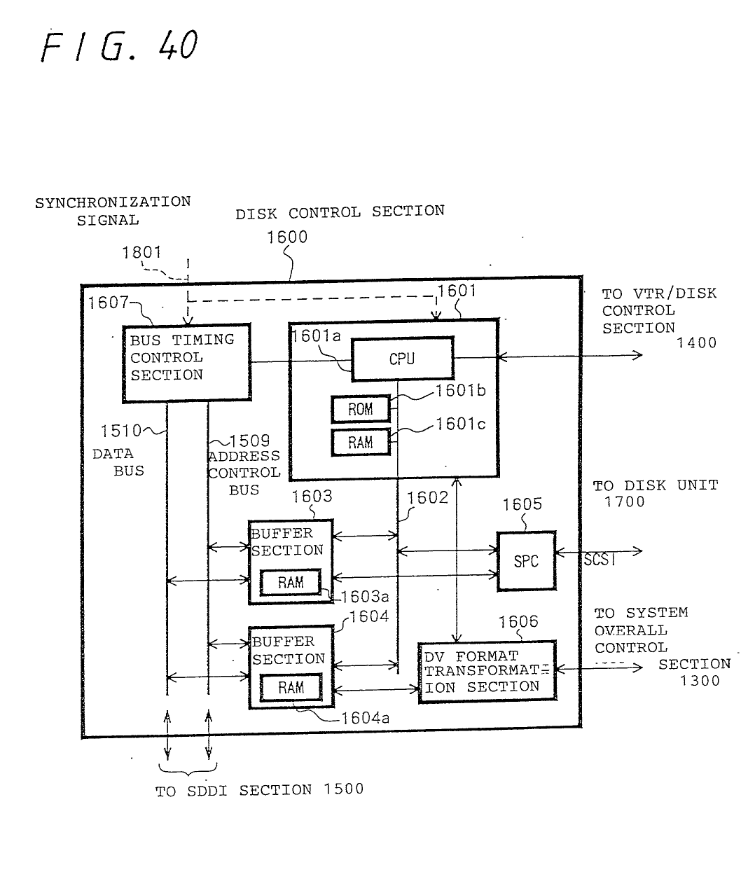

FIG. 40 shows the arrangement of the disk control section 1600. As shown in this figure, the disk control section 1600 comprises: a CPU section 1601 including a CPU 1601a, a ROM 1601b, and a RAM 1601c; buffer sections 1603, 1604 and an SCSI protocol controller (SPC) 1605 which are connected to the CPU section 1601 by an internal control bus 1602; a DV (digital video) format conversion section 1606 connected to the CPU section 1601 by a control wire; and a bus timing control section 1607 connected to the CPU 1601a, the address control bus 1509, and the digital bus 1510. The SPC 1605 is connected to the disk unit 1700 by an SCSI bus. The buffer section 1603 and the SPC 1605, and the buffer section 1604 and the DV format transformation section 1606 are directly connected by data lines, respectively. The buffer section 1603 includes a RAM 1603a, and is connected to the address control bus 1509 and the data bus 1510. The buffer section 1604 includes a RAM 1604a, and is connected to the address control bus 1509 and the data bus 1510. As described in FIG. 39, the address control bus 1509 and the data bus 1510 are connected to the SDDI section 1500. It is arranged that to the CPU section 1601 and the bus timing control section 1607, the synchronization signal 1801 is supplied, so that the both of them perform an action of synchronization.

Next, the action of the disk control section 1600 arranged like this will briefly be described. This disk control section 1600 basically performs a processing (hereafter, referred to as an up load processing) to write the video data and the like which are read out from the digital video cassette recorder 13 and transferred through the SDDI section 1500, into the disk unit 1700, and a processing (hereafter, referred to as a down load processing) to transfer the video data and the like which are read out from the disk unit 1700, to the digital video cassette recorder 13 through the SDDI section 1500, and the timing of the action is controlled by the bus timing control section 1607. Furthermore, the video data described here include the index picture information, too.

Specifically, when receiving an up load command from the VTR/DISK control section 1400, the CPU 1601a controls the bus timing control section 1607, and once stores the video data and the like which are read out from the digital video cassette recorder 13 and transferred on the data bus 1510 from the SDDI section 1500, into the RAM 1603a of the buffer section 1603, and after that, transfers the video data and the like to the disk unit 1700 through the SPC 1605 in a DMA (direct memory access) transfer fashion. On the other hand, when receiving a down load command from the VTR/DISK control section 1400, the CPU 1601a once stores the video data and the like read out from the disk unit 1700, into the RAM 1603a of the buffer section 1603 through the SPC 1605 in the DMA transfer fashion, and after that, transfers the video data and the like to the SDDI section 1500 through the data bus 1510. The video data and the like are further sent to the digital video cassette recorder 13 through the SDDI section 1500 and are recorded thereby.

Furthermore, the disk control section 1600 has a function to perform the mutual transfer of the index picture information between the disk unit 1700 and the system overall control section 1300. In this case, when receiving an IP up load command, the CPU 1601a once stores the index picture information read out from the disk unit 1700 into the RAM 1603a of the buffer section 1603 through the SPC 1605 by the DMA transfer. This index picture information is once stored in the RAM 1604a of the buffer section 1604 through the data bus 1510, and after that, it is transferred to the DV format conversion section 1606 by the DMA transformation, and further, transferred to the system overall control section 1300. On the other hand, when receiving an IP down load command, the CPU 1601a once stores the index picture information sent from the system overall control section 1300 to the DV format conversion section 1606 into the RAM 1604a of the buffer section 1604 by the DMA transmission. This index picture information is once stored in the RAM 1603a of the buffer section 1603 through the data bus 1510, and further, it is transferred to the disk unit 1700 through the SPC 1605 by the DMA transformation, and is written in.

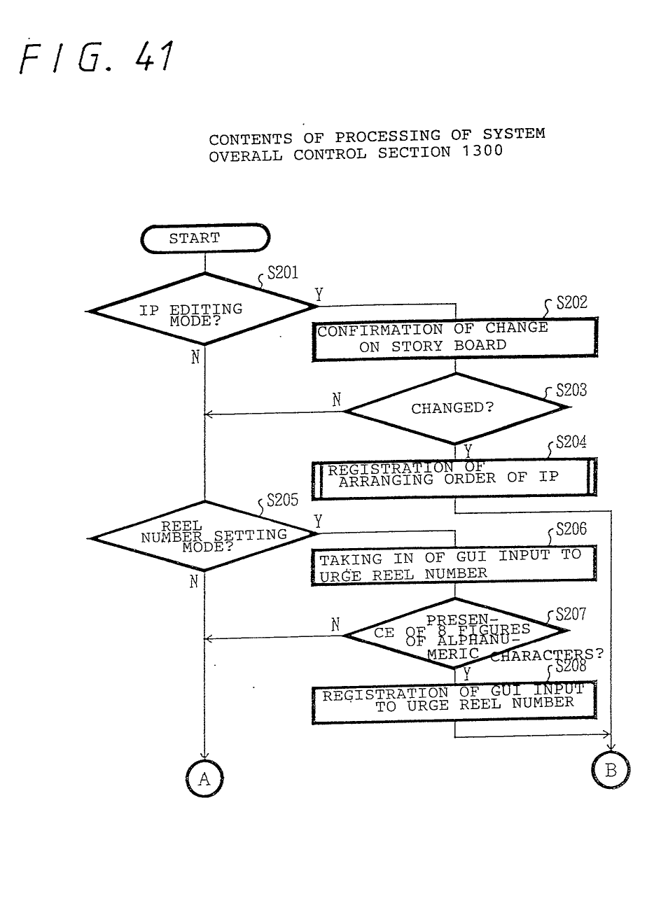

Next, by referring to FIG. 41 to FIG. 53, the contents of processing in the case of performing the editing management of the digital video cassette 12 by using the editing device 14 arranged as mentioned above, will be described.

[Contents of Processing by the Editing Device 14]

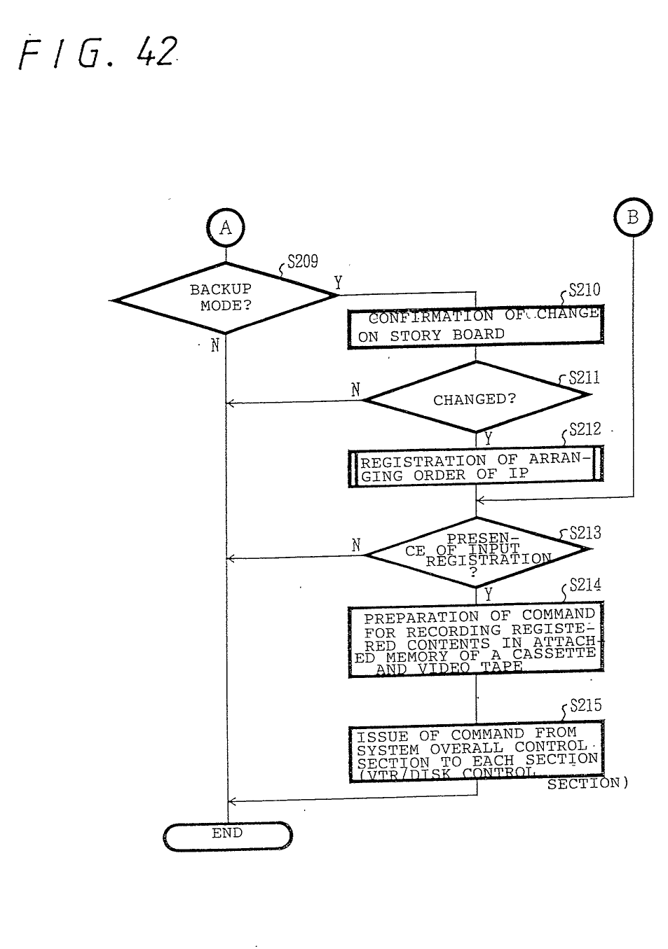

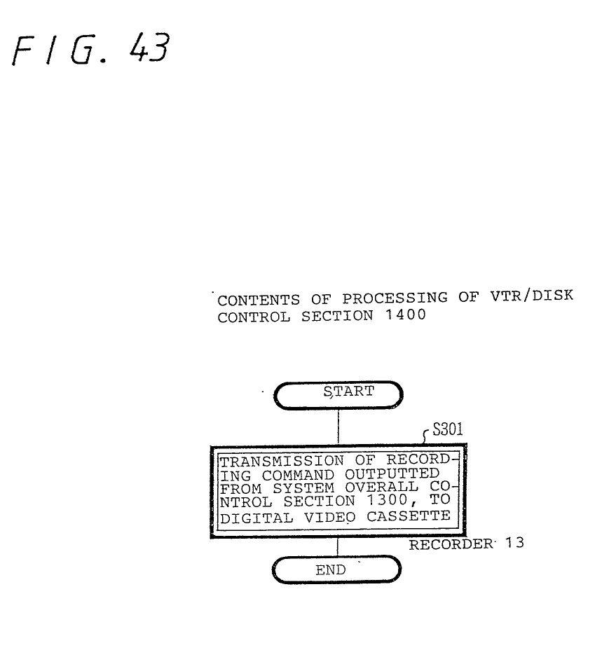

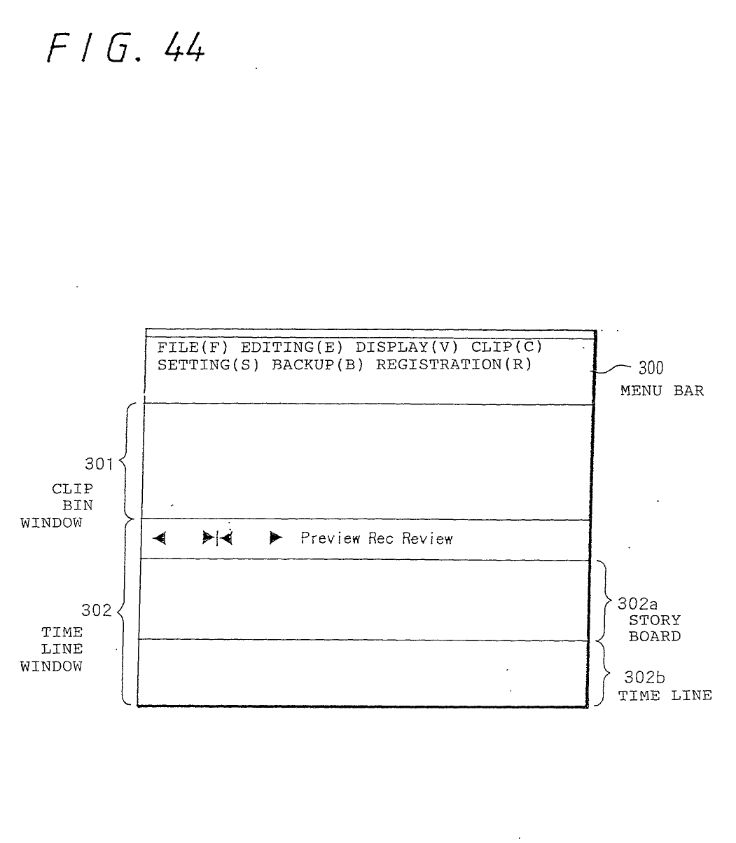

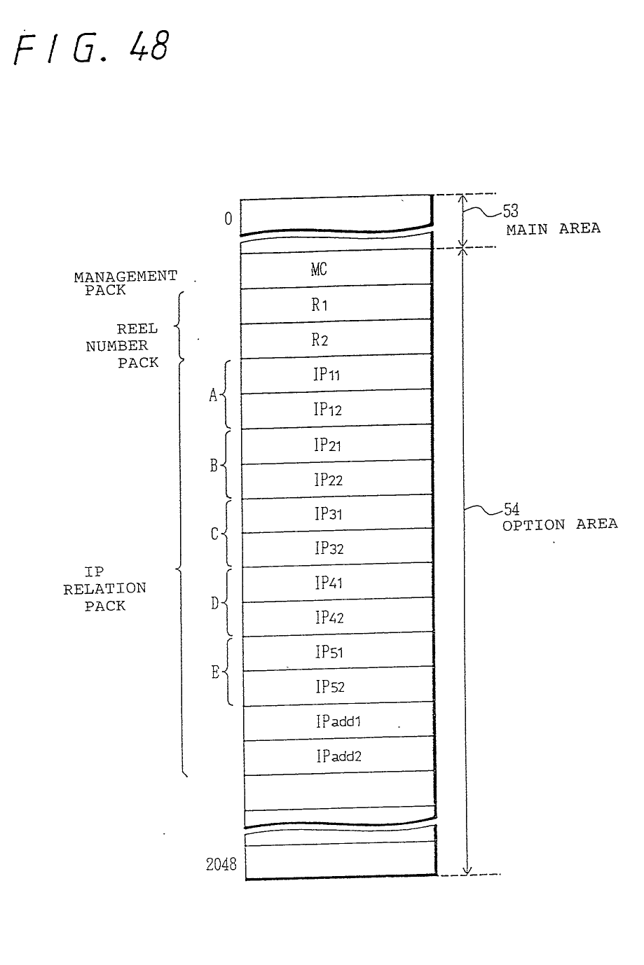

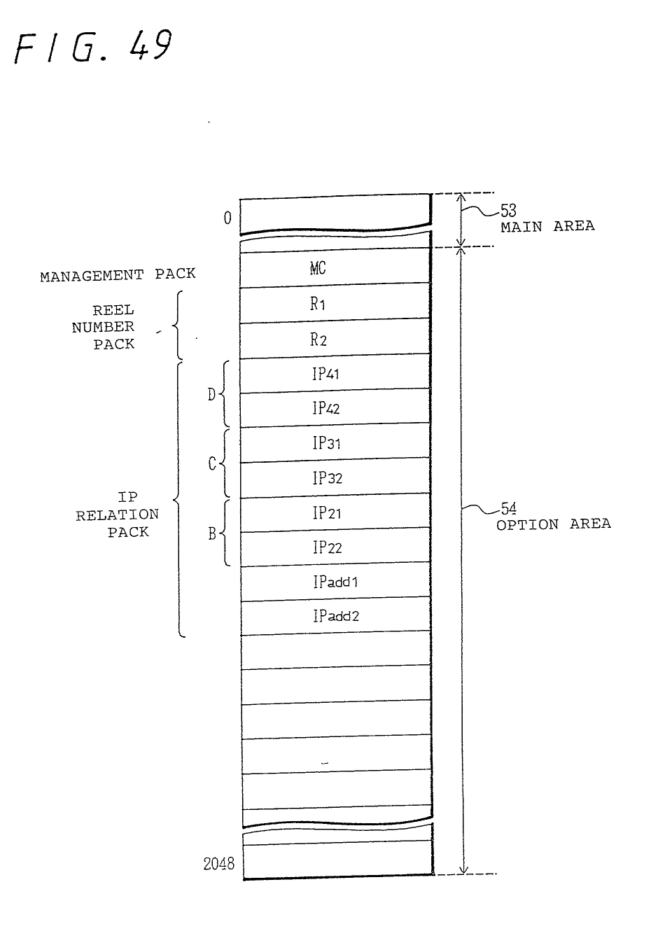

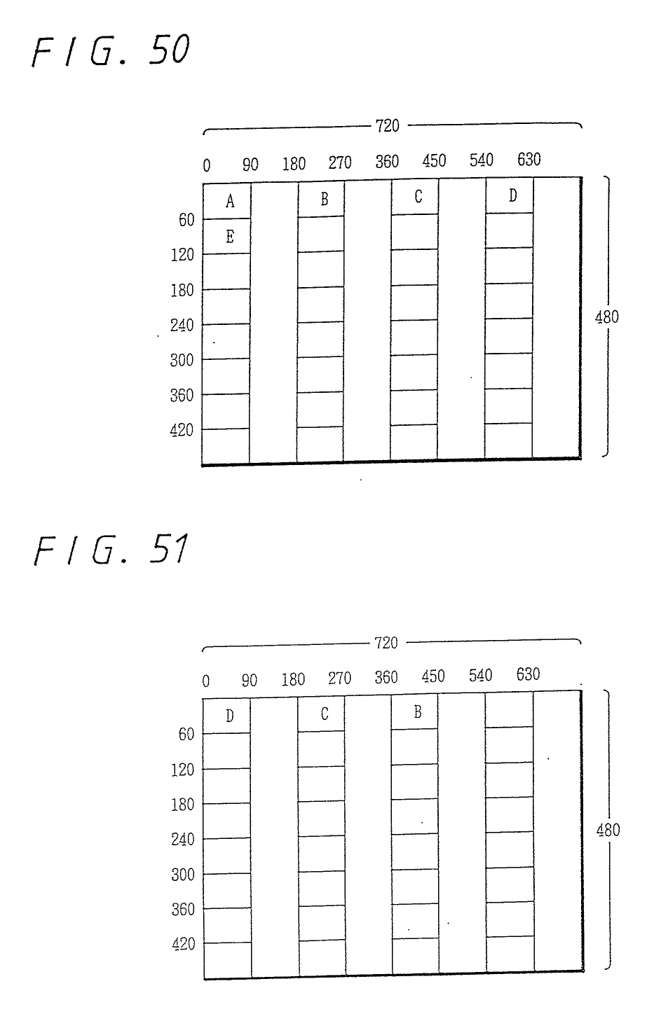

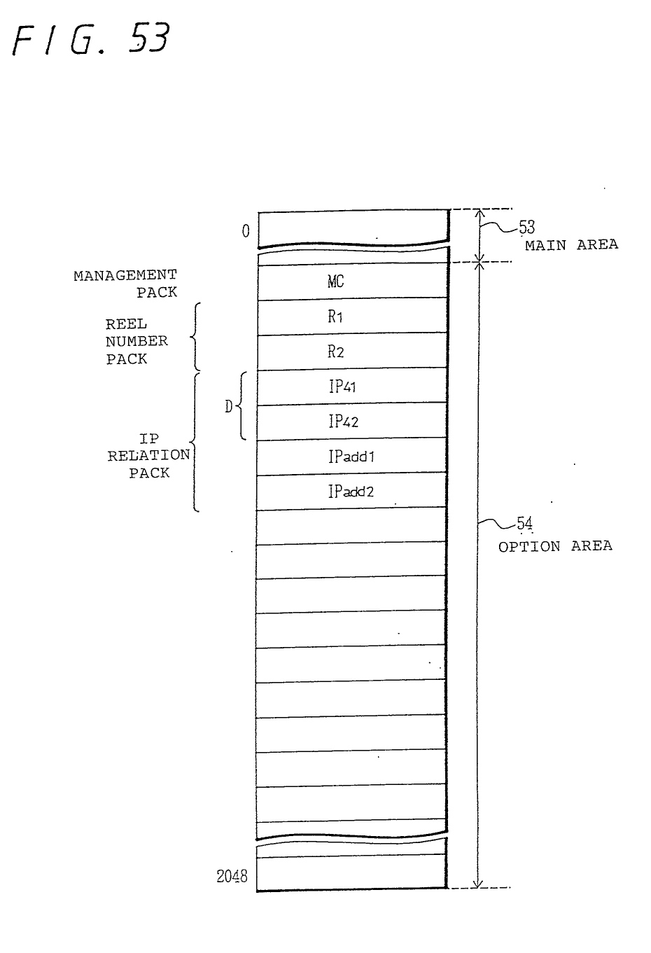

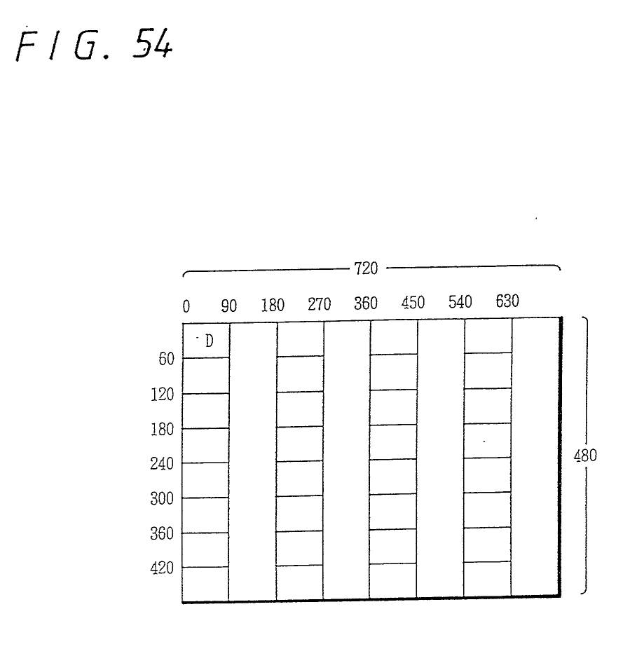

FIG. 41 and FIG. 42 show the principal part of the contents of processing performed by the system overall control section 1300 when performing the editing work of the digital video cassette 12 by using the editing device 14, and FIG. 43 shows the principal part of the contents of processing of the VTR/DISK control section 1400, and FIG. 44 to FIG. 47 and FIG. 52 show an example of the display picture screen of the display section 1200 in the editing device 14, and FIG. 48, FIG. 49, and FIG. 53 show an example of the contents of the memory 1304 of the system overall control section 1300, and FIG. 50, FIG. 51, and FIG. 54 show an example of the set screen of simple index pictures (arrangement of dots in the case where the index picture information of 1 frame is displayed on a picture screen). Here, as mentioned above, the digital video cassette 12 in which the index picture information has already been written on the video tape 27 by the digital video cassette recorder 13 and the IP relation pack has already been written into the attached memory 16 to the cassette, will be described as the subject. Furthermore, the processing of the system overall control section 1300 shown in FIG. 41 and FIG. 42, will be described later.

When the command issued from the system overall control section 1300 of the editing device 14 is sent to the digital video cassette recorder 13 through the VTR/DISK control section 1400 and through the signal cable 1803, the digital video cassette 12 set in the digital video cassette recorder 13 is reproduced, and the video data, the audio data and the sub code are transferred to the editing device 14 through the SDDI cable 1804, and are written in the disk unit 1700 through the SDDI section 1500 and the disk control section 1600. Together with this, from the attached memory 16 to the cassette of the digital video cassette 12, the data (including the IP relation information such as the mark-in point, the mark-out point, the OK/NG, the take number, and the scene number or the like) shown in FIG. 9 are read out, and are transferred to the editing device 14 through the signal cable 1803, and are sent to the system overall control section 1300 through the VTR/DISK control section 1400, and are once written in the external memory device 1309. When performing the editing work by the index picture, the disk control section 1600 reproduces the IP information written in the disk unit 1700, and the index picture information (FIG. 34) contained in the video data written in the disk unit 1700 is transferred to the external memory device 1309 of the system overall control section 1300 and is written in.

FIG. 44 shows one example of the editing picture screen in the display section 1200 in an initial state (state where the contents of the digital video cassette 12 are not read in the editing device 14). As shown in this figure, this editing picture screen comprises: a menu bar 300 in which various types of commands are arranged and displayed; a clip bin window 301 in which simple index pictures of the objects to be edited are temporarily arranged and displayed; and a time line window 302 composed of a story board 302a for arranging and displaying the simple index pictures selected from the clip bin window 301 in the order of storing and a time line 302b for performing various types of editing works.

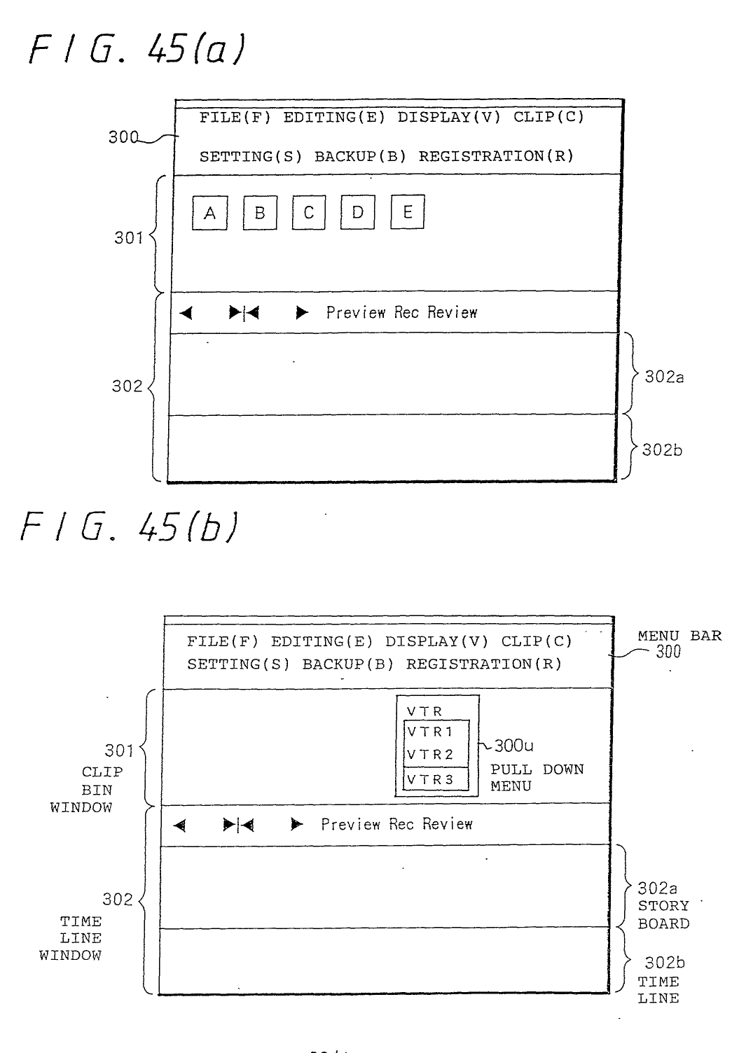

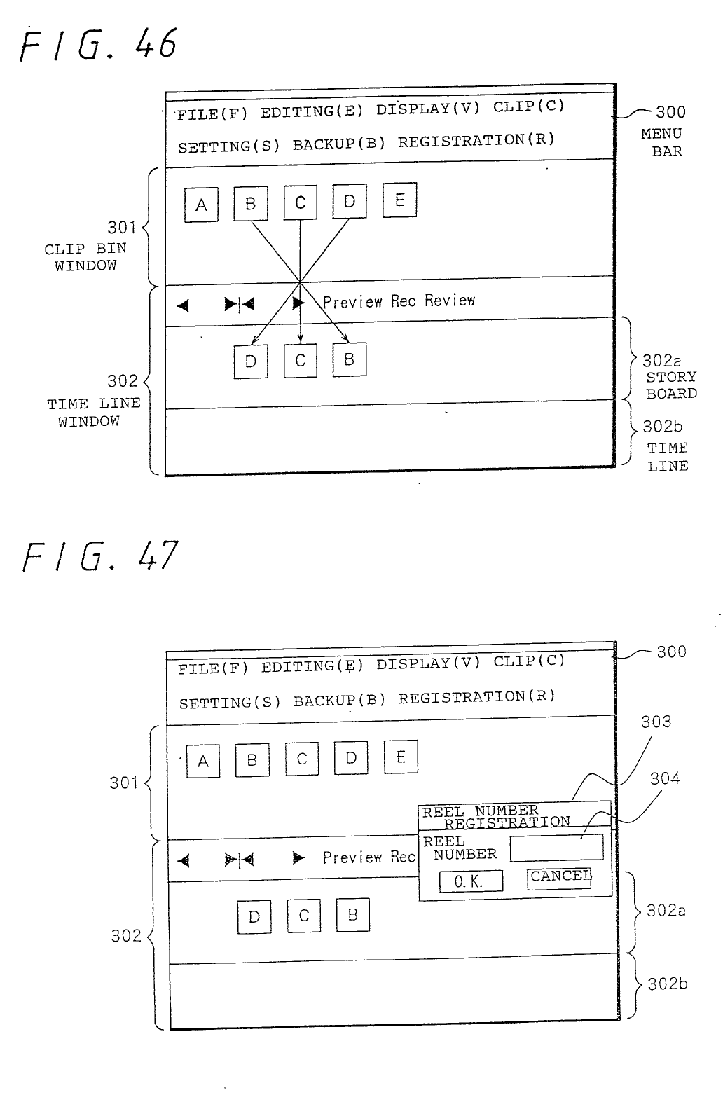

Here, as mentioned above, after the contents of the digital video cassette 12 set in the digital video cassette recorder 13 have been read in the editing device 14, if the frame of index picture information corresponding to the picture materials to be edited is selected by the operational section 1100, the index picture information is read out from the external memory device 1309 of the system overall control section 1300 and transferred to the display section 1200, and for example, as shown in FIG. 45, each of the corresponding simple index pictures is arranged and displayed in the clip bin window 301. Furthermore, in a case where there are a lot of simple index pictures contained in the selected frame, it is arranged that they can be displayed by scrolling the screen of the clip bin window 301 in the horizontal direction.

The example shown in FIG. 45(a) corresponds to the case where the contents of the initial data read in from the attached memory 16 to the cassette of the digital video cassette 12 are, for example, as shown in FIG. 48, and where the contents of the initial index picture information are, for example, as shown in FIG. 50. In this example, as shown in FIG. 48, in the IP relation pack area of the attached memory 16 to the cassette, a plurality of pairs of packs from the packs I P11, I P12 corresponding to a simple index picture A to the packs I P51, I P52 corresponding to a simple index picture E, are recorded in the order thereof. Furthermore, as shown in FIG. 50, the index picture information frame (set screen of simple index pictures) contains each simple index picture information arranged in the order of A to E. Here, for example, the simple index picture A is produced on the basis of the packs I P11, I P12 of FIG. 49 in the digital video cassette recorder 13. Furthermore, the other simple index pictures B to E are similarly produced.

By the way, in order to display the management index pictures as shown in FIG. 45(a) before the editing, the display can be performed, as shown in FIG. 45(b), by selecting a specified item of the menu bar by operating the operational section 1100, and by selecting a desired digital video cassette recorder 13 from the pull down menu.

On the assumption that the state is a state like this, the processing of the system overall control section 1300 (especially, the CPU section 1303) will be described along FIG. 41. The present system has at least 3 modes described below or an IP editing mode; a reel number setting mode; and a backup mode. The processing in each mode will be described below.

First, when the operator clicks [clip (c)] in the menu bar 300 of FIG. 45 by a mouse or the like of the operational section 1100, the system overall control section 1300 judges that the IP editing mode is selected (FIG. 41: step S201), and performs the confirmation of change of the state on the story board 302a of the time line window 302 (step S202).

For example, if the operator clicks the simple index picture D of the clip bin window 301 and next, clicks an arbitrary position of the story board 302a of the time line window 302, as shown in FIG. 46, the simple index picture D is displayed at the position. By performing the same steps for the simple index pictures B, C, the simple index pictures are displayed on the story board 302a in the order of D, C, B.

When the change of the state on the story board 302a like this is confirmed (step S203; Y), the system overall control section 1300 reads out the IP relation pack data (FIG. 48) from the external memory device 1309 to the memory 1304 (FIG. 37) of the system overall control section 1300, and rearranges the contents thereof in the order as shown in FIG. 49 (order of D, C, B), and at the same time, it reads out the index picture information (FIG. 50) from the external memory device 1309 to the memory 1304, and rearranges the contents thereof in the order as shown in FIG. 51 (order of D, C, B). Then, it transfers again those to the external memory device 1309, and writes in those and registers those. (step S204).

Furthermore, in FIG. 46, if the operator clicks [setting (S)] in the menu bar 300 of FIG. 45 by the mouse or the like of the operational section 1100, the system overall control section 1300 judges that the reel number setting mode is selected (step S205; Y), and as shown in FIG. 47, it displays the reel number registration window 303 by the GUI (graphical.user.interface) of the display section 1200, and urges the input of the reel number (step S206). Here, if for example, a reel number of 8 figures of alphanumeric characters is inputted into the reel number input area 304 and [O, K] is clicked (step S207), the reel number is registered in the external memory device 1309 of the system overall control section 1300. Here, the reel number corresponds to the management information in the present invention.

Furthermore, in FIG. 45, if the operator clicks [backup (B)] in the menu bar 300 by the mouse or the like of the operational section 1100, the system overall control section 1300 judges that the backup mode is selected (FIG. 42; step S209), and performs confirmation of the change of the state on the story board 302a of the time line window 302 (step S210).

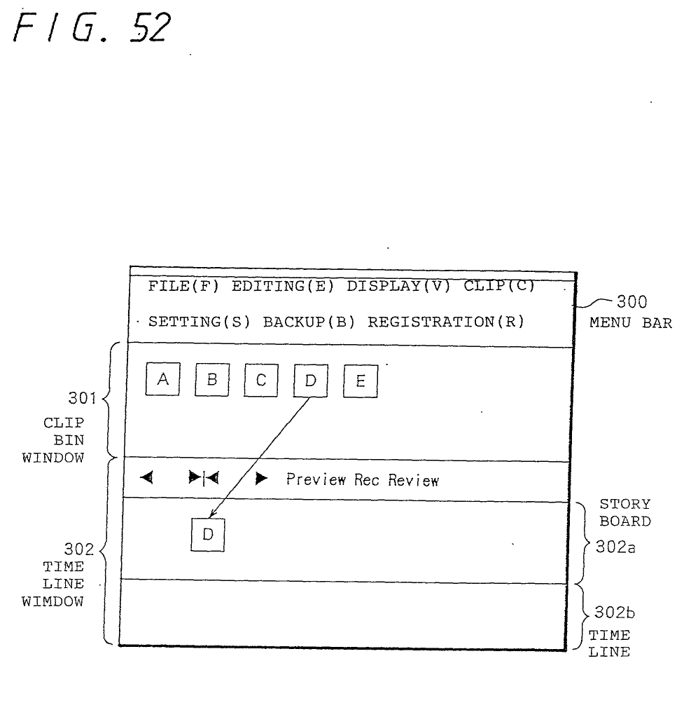

For example, in a case of backing up the simple interface picture D, as shown in FIG. 52, the simple interface picture D of the clip bin window 301 is clicked and next, an arbitrary position of the story board 302a of the time line window 302 is clicked. Consequently, the simple interface picture D is displayed at the position.

When confirming the change of the state on the story board 302a like this (step S11; Y), the system overall control section 1300 performs processing similar to that in the case of the IP editing mode. That is, it reads out the IP relation pack data from the external memory device 1309 of the system overall control section 1300 to the memory 1304, and changes the contents thereof to be only the packs I P41, I P42 corresponding to the simple index picture D as shown in FIG. 53 from the packs corresponding to the simple index pictures A, B, C, D, E shown in FIG. 48, and at the same time, it reads out the index picture information from the external memory device 1309 to the memory 1304, and changes the contents thereof to be only the simple index picture D as shown in FIG. 54. Then, it transfers those again to the external memory device 1309, and writes in those and registers those (step S212).

By the way, in the above description, the old data (IP relation pack and index picture information) of the external memory device 1309 in the system overall control section 1300 may be replaced by the changed new data, or the old data may be kept apart from the new data.

By the way, in the state of FIG. 46, FIG. 47, or FIG. 52, if [registration (R)] in the menu bar 300 is clicked, the system overall control section 1300 produces a command to record the registered contents, that is, the changed index picture information stored in the external memory device 1309 and the pack data on each of the video tape 27 and the attached memory 16 to the cassette of the digital video cassette 12 (step S214), and issues the same to each section (such as the VTR/DISK control section 1400 and so on) (step S215).

The VTR/DISK control section 1400 having received this command sends out the command to the digital video cassette recorder 13 through the signal cable 1803 (FIG. 43: step S301). Furthermore, the disk control section 1600 performs preparation for sending out the data on the disk unit 1700 to the digital video cassette recorder 13 through the SDDI section 1500.

On the other hand, on the side of the digital video cassette recorder 13, another digital video cassette (for example, a master tape, a backup tape, or the like) for recording the edited data is set in advance. Then, when the preparation of the digital video cassette recorder 13 is completed, the system overall control section 1300 of the editing device 14 issues an internal command for starting the data transfer from the disk unit 1700 to the digital video cassette recorder 13, to the disk control section 1600.

As shown in FIG. 46, in the case of performing the processing in the IP editing mode, a master tape is set in the digital video cassette recorder 13. The disk control section 1600 of the editing device 14 retrieves the video data and the like on the disk unit 1700 according to the order of pack data shown in FIG. 49, and transfers those in turn to the digital video cassette recorder 13 through the SDDI section 1500. In this example, the video data and the like are transferred in the order corresponding to the simple index pictures D, C, B. When this transfer is finished, the disk control section 1600 reads out the changed index picture information (FIG. 51) stored in the external memory device 1309 of the system overall control section 1300, and transfers the same to the digital video cassette recorder 13. Furthermore, the VTR/DISK control section 1400 reads out the changed pack data (FIG. 49) from the external memory device 1309 of the system overall control section 1300, and transfers the data to the digital video cassette recorder 13.

Furthermore, as shown in FIG. 52, in the case of performing the processing in the backup mode, a backup tape is set in the digital video cassette recorder 13. The disk control section 1600 of the editing device 14 retrieves the video data and the like on the disk unit 1700 according to the pack data shown in FIG. 53, and transfers those in turn to the digital video cassette recorder 13 through the SDDI section 1500. In this example, the video data and the like are transferred corresponding to the simple index pictures D. After this transfer has been finished, the disk control section 1600 reads out the changed index picture information (FIG. 54) stored in the external memory device 1309 of the system overall control section 1300, and transfers the same to the digital video cassette recorder 13. Furthermore, the VTR/DISK control section 1400 reads out the changed pack data (FIG. 53) from the external memory device 1309 of the system overall control section 1300, and transfers the data to the digital video cassette recorder 13.

In the digital video cassette recorder 13, the video data and the like transferred in turn from the editing device 14 are recorded in that order on the video tape 27 (a master tape or a backup tape) set corresponding to each mode, and at the same time, the edited index picture information is recorded at a specified position on the tape (for example, after the storing end point RE in FIG. 31), and further, in the attached memory 16 to the cassette, the edited pack data transferred from the editing device 14 are recorded. The pack data are also recorded in the sub code section 64 of the video tape 27.

Thus, in the case of the IP editing mode, the picture materials in the state where the editing is finished and the index picture information (FIG. 51) in the order corresponding thereto are recorded in the master tape set in the digital video cassette 12, and at the same time, in the attached memory 16 to the cassette and the sub code section 64 of the video tape 27, the pack data (FIG. 49) are stored in the order after the editing.

Furthermore, in the case of the backup mode, the picture materials selected as the object of backup and the index picture information (FIG. 54) corresponding thereto are recorded in the backup tape set in the digital video cassette 12, and at the same time, in the attached memory 16 to the cassette and the sub code section 64 of the video tape 27, the changed pack data (FIG. 53) are stored.

As described above, by the picture management system according to the present embodiment, it is arranged that the index picture information indicating the simple index picture is produced on the basis of the index information such as the mark-in point, the mark-out point or the like, and then is added to the picture materials on the video tape, and at the same time, the editing is performed while the index picture information is linked to the picture materials, and therefore, the simple index picture functions as, so to speak, the table of contents indicating the rough contents of the picture materials, and the editing work becomes extremely easy. Furthermore, at the time of the editing work and the like, the confirming work of the picture materials recorded on the video tape can be performed rapidly and easily. Furthermore, in the present embodiment, the simple index picture is added, not only to the unedited video tape, but also to the edited video tape or the video tape in the course of editing, and therefore, by utilizing this simple index picture, regardless of the state and type of the video tape: an edited tape, a tape in the course of editing, and an unedited tape, these video tapes can be managed unitarily.

Furthermore, in the present embodiment, since it is arranged that the simple index picture is also added to the picture materials recorded on a backup video tape for the backup, the management of the backup video tape also becomes easy.

Furthermore, since it is arranged that the edited result is displayed in the story board 302a by the simple index picture, the rough contents of the edited video tape can be grasped at the instant.

Furthermore, since it is arranged that a reel number is added to an edited video tape, a video tape in the course of editing, or a backup video tape, regardless of the state and type of the recording medium, the management of the recording media can surely be performed.

Furthermore, in the present embodiment, even if the index picture information is not produced at the time of picture taking, it is possible that the index picture information is produced later on the basis of the index information information of the mark-in point and the scene number) recorded in the attached memory 16 to the cassette and the video tape 27, and is recorded on the video tape 27. Accordingly, even in the case of performing the picture taking by using an equipment with no function to produce the index picture information at the time of picture taking, it is possible to increase the efficiency of the editing work (improvement of searching a head at a desired position on the video tape 27, rough introduction of picture information recorded on the video tape 27, or the like) by using the index picture information, later.

Furthermore, in the present embodiment, it is possible that a picture agreeing with the desired conditions is selected to be the index picture on the basis of the index information and the additional information, and consequently, it is possible to further improve the efficiency of the editing work.

Furthermore, in the present embodiment, since it is arranged that the index information and the additional information are recorded both in the attached memory 16 to the cassette and on the video tape 27, it is possible that the index picture information is produced later and recorded on the video tape 27, even in the case where the picture taking is performed using a digital video cassette 12 with no attached memory 16 to the cassette.

The present invention has been described above, while exemplifying some embodiments, but the present invention is not limited to these embodiments, and various types of modifications are possible in the range of equality thereof. For example, in the embodiment, an example in which the reel number is added to the edited video tape has been described, but the present invention is not limited thereto, and it is also possible that the reel number is also added to a video tape in the course of editing or an unedited video tape, or a backup tape.

Furthermore, in the present embodiment, it is arranged that the index information and the additional information are recorded both in the attached memory 16 to the cassette and on the video tape 27, but it is also possible to record the same only on either. Furthermore, in the embodiment, it is arranged that the time code of the recording position on the video tape 27 of the index picture information is also recorded both in the attached memory 16 to the cassette and on the video tape 27, but it is also possible to record that only on either.

Furthermore, in the embodiment, it is arranged that at the time of production of the index picture information, the index information and the additional information recorded in the attached memory 16 to the cassette are used, but it is also possible to use the index information and the additional information recorded on the video tape 27.

Furthermore, in the embodiment, an example in which the picture of the mark-in point is made to be the index picture has been described, but the present invention is not limited to this, and for example, the picture at the time of start of picture taking of each scene or take may be made to be the index picture, or the picture of the cue point may be made to be the index picture at the time of selecting the cue mode. In this case, it is possible that the index picture information is produced on the basis of the index picture at the cue point and is added to the picture materials to be served upon the following editing work, or the management of materials is performed by using the index picture information of the cue point.

Furthermore, it is also possible that the digital VTR section in the camera.recorder 11 is arranged as shown in FIG. 3 so that production and recording of the index picture information may be performed in this digital VTR section. In this case, the digital VTR section in the camera.recorder 11 corresponds to the simple index picture producing means in the present invention.

As described above, according to this picture management system, it is arranged that the index picture is selected from the picture information on a recording medium on the basis of the index information, and on the basis of this index picture, a simple index picture is produced, and the produced simple index picture is added to each picture information on the recording medium, and the simple index picture is treated while being linked with the picture information on the recording medium, and therefore, this simple index picture functions as, so to speak, the table of contents showing the rough contents of the picture materials recorded on the recording medium. Accordingly, by utility this simple index picture, the editing work or the confirming work of the picture materials on the recording medium can be performed rapidly and easily. Furthermore, there is such an effect that the picture materials on the recording medium can be managed unitarily regardless of the state and type of the recording medium: an edited medium, a medium in the course of editing, or an unedited medium.

Furthermore, according to this picture management system, since it is arranged that a simple index picture is added to each picture information on an edited recording medium or a recording medium in the course of editing, there is such an effect that the management of an edited recording medium or a recording medium in the course of editing, becomes easy.

Furthermore, according to this picture management system, since it is arranged that a simple index picture is added to each picture information on the backup recording medium in which the picture information is recorded for the backup, there is such an effect that the management of the backup recording medium becomes easy.

Furthermore, according to this picture management system, since it is arranged that a simple index picture is displayed as the guidance for the results of editing, there is such an effect that the outline of the picture materials recorded on the recording medium can immediately be grasped.

Furthermore, according to this picture management system, since it is arranged that the management information is added to an edited recording medium or a recording medium in the course of editing, or a backup recording medium, there is such an effect that regardless of the state and type of the recording medium, the picture materials recorded on the recording media can unitarily be managed.

Explanation of the Reference Marks

11 . . . the camera.recorder

12 . . . the digital video cassette

13 . . . the digital video cassette recorder

14 . . . the editing device

16 . . . the attached memory to a cassette

20 . . . the digital VTR section

27 . . . the video tape

33 . . . the operational section

35 . . . the controller

40 . . . the index producing section

41 . . . the index memory

1100 . . . the operational section

1200 . . . the display section

1300 . . . the system overall control section

1400 . . . the VTR/DISK control section

1500 . . . the SDDI section

1600 . . . the digital control section

1700 . . . the disk unit

1304 . . . the memory

1309 . . . the external memory device

What is claimed is:

1. A picture management system being characterized by comprising:
a simple index picture producing means for producing a simple index picture on the basis of an index picture selected on the basis of an index information for specifying an editing point or an editing range on a recording medium from among a picture information recorded on said recording medium;
a simple index picture adding means for adding said simple index picture produced by said simple index picture producing means to each of said picture informations recorded-on said recording medium; and
a picture editing processing means for edit-processing said picture information recorded on said recording medium on in link with the simple index picture added by said simple index picture adding means.

2. The picture management system as claimed in claim 1, characterized in that said simple index picture adding means adds said simple index picture to each of said picture information on at least an edited recording medium or a recording medium in the course of editing.

3. The picture management system as claimed in claim 1, characterized in that said simple index picture adding means adds said simple index picture to each picture information on a backup recording medium in which at least said picture information is copied for backup.

4. The picture management system according to claim 1, characterized by further comprising a display means for displaying said simple index picture as a result of editing.

5. The picture management system according to claim 1, characterized by further comprising a management information adding means for adding a management information for the sake of managing the recording medium, to an edited recording medium or a recording medium in the course of editing, or a backup recording medium in which said picture information is copied for backup.

6. The picture management system as claimed in claim 5, characterized in that said management information includes a discriminating information of each of said recording media.

7. A picture management method being characterized by comprising:
a simple index picture producing step which selects an index picture on the basis of an index information for specifying an editing point or an editing range on a recording medium from among a picture information recorded on said recording medium, and producing a simple index picture capable of being simply displayed on the basis of the selected index picture;
a simple index picture adding step for adding said simple index picture produced by said simple index picture producing step to each picture information recorded on said recording medium; and
an edition processing step for edition processing said picture information recorded on said recording medium in link with the simple index picture added by said simple index picture adding step.

8. The picture management method as claimed in claim 7, characterized in that said simple index picture adding step adds said simple index picture to each of said picture information on at least an edited recording medium or a recording medium in the course of editing.

9. The picture management method as claimed in claim 7, characterized in that said simple index picture adding step adds said simple index picture to each of said picture information on a backup recording medium in which at least said picture information is copied for backup.

10. The picture management method according to in claim 7, characterized by further comprising a management information adding step for adding a management information to manage said recording medium to an edited recording medium or a recording medium in the course of editing, or a backup recording medium in which said picture information is copied for backup.

11. The picture management method as claimed in claim 7, characterized in that said management information includes a discriminating information of each of said recording media.
